(19) United States
(12) Patent Application Publication
(10) Pub. No.: US 2013/0206234 A1
(43) Pub. Date: Aug. 15, 2013

(54) ELECTROLYTE FOR PHOTOELECTRIC CONVERSION ELEMENT, AND PHOTOELECTRIC CONVERSION ELEMENT AND DYE-SENSITISED SOLAR CELL USING SAME

(71) Applicant: Tsukasa Maruyama, Kanagawa (JP)

(72) Inventor: Tsukasa Maruyama, Kanagawa (JP)

(73) Assignee: THE YOKOHAMA RUBBER CO., LTD., MINATO-KU, TOKYO (JP)

(21) Appl. No.: 13/878,766

(22) PCT Filed: Oct. 12, 2011
(86) PCT No.: PCT/JP2011/073450

§ 371 Date: Apr. 11, 2013

(30) Foreign Application Priority Data
Oct. 12, 2010 (JP) 2010-229395

(51) Int. Cl. H01G 9/20

(52) U.S. Cl. CPC H01G 9/2013
USPC 136/263; 252/62.2

(57) ABSTRACT

The object of the present invention is to provide an electrolyte for a photoelectric conversion element capable of obtaining a dye-sensitized solar cell having excellent stability. The electrolyte for a photoelectric conversion element of the present invention is an electrolyte for a photoelectric conversion element that contains an organic salt compound (A) having a tertiary or quaternary cation and an organically modified lamellar double hydroxide (B).

### TECHNICAL FIELD

The present invention relates to an electrolyte for a photoelectric conversion element, and a photoelectric conversion element and a dye-sensitized solar cell using the electrolyte.

### BACKGROUND OF THE INVENTION

In recent years, environmental issues such as global warming and the like that are attributed to increases in carbon dioxide have become serious. As a result, non-silicon solar cells have gained attention as solar cells that have little environmental impact and that also allow for reduced manufacturing costs; and research and development of such is moving forward.

Among non-silicon solar cells, the dye-sensitized solar cell developed by Graetzel et al. in Switzerland has attracted attention as a new type of solar cell. As a solar cell using organic materials, these solar cells have advantages such as high photoelectric conversion efficiency and lower manufacturing costs than silicon solar cells, and the like.

However, dye-sensitized solar cells are electrochemical cells, and therefore use organic electrolytic solutions and/or ionic liquids as electrolytes. In cases where organic electrolytic solutions are used, there is a problem in that electrical efficiency decreases due to volatilization and depletion during long-term use. Additionally, in cases where ionic liquids are used, while volatilization and depletion that occur during long-term use can be prevented, there are durability problems such as structural degradation caused by liquid leakage.

Thus, research is performed to change from a liquid type electrolyte to a gel type electrolyte and a solid type electrolyte with the goal of preventing volatilization and leakage of the electrolyte solution and securing stability for a solar cell.

For example, Patent Document 1 describes an electrolyte for a photoelectric conversion element comprising (i) a lamellar clay mineral and/or an organically modified lamellar clay mineral and (ii) an ionic liquid (claim 1).

### PRIOR ART DOCUMENTS

### Patent Documents

Patent Document 1: Japanese Unexamined Patent Application Publication (translation of PCT application) No. 2007-531206

### SUMMARY OF THE INVENTION

### Problem to be Solved by the Invention

The object of the present invention is to provide an electrolyte for a photoelectric conversion element capable of obtaining a dye-sensitized solar cell that has excellent stability in the same manner as the invention disclosed in Patent Document 1.

### Means to Solve the Problem

As a result of dedicated investigations in order to solve the aforementioned problem, the inventors of the present invention accomplished the present invention by discovery that a gel type electrolyte was obtained and that volatilization, leakage, or the like could be suppressed by joint use of a specific organic salt compound and a lamellar double hydroxide (LDH) that has been subjected to organomodification.

Specifically, the present invention provides the following (1) to (7).

(1) An electrolyte for a photoelectric conversion element containing an organic salt compound (A) having a tertiary or quaternary cation and an organically modified lamellar double hydroxide (B).

(2) The electrolyte for a photoelectric conversion element according to the above (1), wherein the organically modified lamellar double hydroxide (B) is a lamellar double hydroxide that has been subjected to organomodification using an organic anion having three or more carbon atoms.

(3) The electrolyte for a photoelectric conversion element according to the above (1) or (2), wherein the organically modified lamellar double hydroxide (B) is a lamellar double hydroxide that has been subjected to organomodification using an organic anion having an onium base.

(4) The electrolyte for a photoelectric conversion element according to the above (3), wherein the onium base is at least one type selected from the group consisting of the imidazolium base, pyridinium base, pyrrolidinium base, piperidinium base, ammonium base, sulfonium base, phosphonium base, or the like.

(5) The electrolyte for a photoelectric conversion element according to the above (1) to (4), wherein the above organic salt compound (A) has a thiocyanate anion.

(6) A photoelectric conversion element including: a photoelectrode including a transparent conductive film and a metal oxide semiconductor porous film; a counter electrode disposed opposite the photoelectrode; and an electrolyte layer disposed between the photoelectrode and the counter electrode, where the electrolyte layer is an electrolyte for a photoelectric conversion element described in any one of the above (1) to (5).

(7) A dye-sensitized solar cell including the photoelectric conversion element described in the above (6), wherein the photoelectrode of the photoelectric conversion element is carrying a photosensitizing dye.

### Effect of the Invention

According to the present invention, an electrolyte for a photoelectric conversion element from which a dye-sensitized solar cell can be obtained that has excellent stability can be provided.

### BRIEF DESCRIPTION OF THE DRAWINGS

FIG. 1 is a schematic cross-sectional view illustrating an example of a basic configuration of a photoelectric conversion element of the present invention.

FIG. 2 is a drawing illustrating a basic configuration of a solar cell of the present invention used in the Working Examples and the like.

### BEST MODE FOR CARRYING OUT THE INVENTION

### <Electrolyte for a Photoelectric Conversion Element>

The electrolyte for a photoelectric conversion element of the present invention (referred to below simply as the “electrolyte of the present invention”) is an electrolyte for a photoelectric conversion element that contains: an organic salt compound (A) having a tertiary or quaternary cation, and an organically modified lamellar double hydroxide (B), i.e. a lamellar double hydroxide that has been subjected to organomodification using an organic anion.

Next, each constituent of the electrolyte of the present invention will be described in detail.

### <Organic Salt Compound (A)>

The organic salt compound (A) used in the electrolyte of the present invention is an organic salt compound that has a tertiary or quaternary cation as well as its counter ion (i.e. anion). The organic salt compound (A) used in the electrolyte of the present invention is preferably a liquid at room temperature, i.e. is a so-called ionic liquid.

Here, “tertiary cation” refers to a cation of a periodic table group 16 element (e.g. oxygen atom, sulfur atom, or the like) having a positive charge that does not include a hydrogen atom. “Quaternary cation” refers to a cation of a periodic table group 15 element (e.g. nitrogen atom, phosphorous atom, or the like) having a positive charge that does not include a hydrogen atom.

Specific preferred examples of the aforementioned organic salt compound (A) include the cations indicated by the below Formulae (1) and (2).

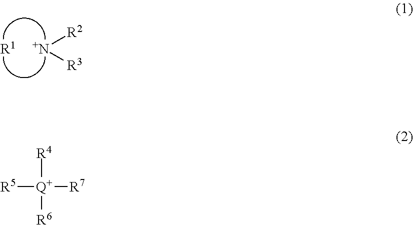

In Formula (1), R¹ is a hydrocarbon group having from 1 to 20 carbons that may contain a hetero atom, and may include a substituent having from 1 to 20 carbons that may contain a hetero atom. R² and R³ are each independently a hydrogen atom or a hydrocarbon group having from 1 to 20 carbons, and may include a hetero atom. However, the R³ moiety is absent if the nitrogen atom contains a double bond.

In formula (2), Q is a nitrogen, oxygen, phosphorus, or sulfur atom; and R⁴, R⁵, R⁶, and R⁷ are each independently a hydrogen atom or a hydrocarbon group having from 1 to 8 carbons that may include a hetero atom. However, the R⁷ moiety is absent if Q is an oxygen or a sulfur atom and, if Q is a sulfur atom, R⁴ and R⁵ may be linked.

The hydrocarbon group in Formula (1) having from 1 to 20 carbons that may contain a hetero atom, R¹, preferably has a ring structure along with the nitrogen atom (ammonium ion) in Formula (1).

Next, preferable examples of the substituent, having from 1 to 20 carbons and that may contain a hetero atom that R¹ in Formula (1) may include, include alkyl groups having from 1 to 20 carbons (e.g. a methyl group, an ethyl group, a propyl group, a butyl group, a pentyl group, a hexyl group, a heptyl group, an octyl group, an ethylhexyl group, a nonyl group, a decyl group, a dodecyl group, an undecyl group, a hexadecyl group, an octadecyl group, a cyclopropylmethyl group, a trifluoroethyl group, and the like); alkenyl groups having from 2 to 20 carbons (e.g. a vinyl group, an allyl group, and the like); aryl groups having from 6 to 20 carbons (e.g. a phenyl group, a tolyl group, a naphthyl group, and the like); aralkyl groups having from 7 to 20 carbons (e.g. a benzyl group, a phenylethyl group, a phenylpropyl group, and the like); alkoxy groups having from 1 to 20 carbons (e.g. a methoxy group, an ethoxy group, an n-propoxy group, an iso-propoxy group, an n-butoxy group, a tert-butoxy group, a sec-butoxy group, an n-pentoxy group, an n-hexoxy group, a 1,2-dimethylbutoxy group, a heptoxy group, an octoxy group, a nonynoxy group, a decyloxy group, a phenoxy group, a methyl phenoxy group, an ethyl phenoxy group, and the like); and alkylalkoxy groups having from 2 to 20 carbons (e.g. a methylene methoxy group (—CH₂OCH₃), an ethylene methoxy group (—CH₂CH₂OCH₃), an n-propylene-iso-propoxy group (—CH₂CH₂CH₂OCH(CH₃)₂), a methylene-t-butoxy group (—CH₂—O—C(CH₃)₃), a butylene methoxy group, a pentylene methoxy group, a hexylene methoxy group, a heptylene methoxy group, an octylene methoxy group, a nonylene methoxy group, a decylene methoxy group, a methylene ethoxy group, an ethylene ethoxy group, a propylene ethoxy group, a butylene ethoxy group, a pentylene ethoxy group, a hexylene ethoxy group, an ethylene ethoxy methoxy group, a cyclopropyl methoxy group, a cyclohexyl methoxy group, a methyl phenoxy group, a methoxy phenoxy group, an ethoxy phenoxy group, a phenoxy phenoxy group, and the like). Additionally, R¹ in Formula (1) may include two or more of these substituents.

Next, specific examples of the hydrocarbon group, having from 1 to 20 carbons and that may contain a hetero atom, R² and R³, in Formula (1) include, include alkyl groups having from 1 to 20 carbons (e.g. a methyl group, an ethyl group, a propyl group, a butyl group, a pentyl group, a hexyl group, a heptyl group, an octyl group, an ethylhexyl group, a nonyl group, a decyl group, a dodecyl group, an undecyl group, a hexadecyl group, an octadecyl group, a cyclopropylmethyl group, a trifluoroethyl group, and the like); alkenyl groups having from 2 to 20 carbons (e.g. a vinyl group, an allyl group, and the like); aryl groups having from 6 to 20 carbons (e.g. a phenyl group, a tolyl group, a naphthyl group, and the like); aralkyl groups having from 7 to 20 carbons (e.g. a benzyl group, a phenylethyl group, a phenylpropyl group, and the like); alkoxy groups having from 1 to 20 carbons (e.g. a methoxy group, an ethoxy group, an n-propoxy group, an iso-propoxy group, an n-butoxy group, a tert-butoxy group, a sec-butoxy group, an n-pentoxy group, an n-hexoxy group, a 1,2-dimethylbutoxy group, a heptoxy group, an octoxy group, a nonynoxy group, a decyloxy group, a phenoxy group, a methyl phenoxy group, an ethyl phenoxy group, and the like); and alkylalkoxy groups having from 2 to 20 carbons (e.g. a methylene methoxy group (—CH₂OCH₃), an ethylene methoxy group (—CH₂CH₂OCH₃), an n-propylene-iso-propoxy group (—CH₂CH₂CH₂OCH(CH₃)₂), a methylene-t-butoxy group (—CH₂—O—C(CH₃)₃), a butylene methoxy group, a pentylene methoxy group, a hexylene methoxy group, a heptylene methoxy group, an octylene methoxy group, a nonylene methoxy group, a decylene methoxy group, a methylene ethoxy group, an ethylene ethoxy group, a propylene ethoxy group, a butylene ethoxy group, a pentylene ethoxy group, a hexylene ethoxy group, an ethylene ethoxy methoxy group, a cyclopropyl methoxy group, a cyclohexyl methoxy group, a methyl phenoxy group, a methoxy phenoxy group, an ethoxy phenoxy group, a phenoxy phenoxy group, and the like).

Additionally, preferable specific examples of the hydrocarbon group, having from 1 to 8 carbons and that may contain a hetero atom, R⁷, R⁶, R⁵, and R⁴ in Formula (2) include alkyl groups having from 1 to 8 carbons (e.g. a methyl group, an ethyl group, a propyl group, a butyl group, a pentyl group, a hexyl group, a heptyl group, an octyl group, and the like), alkoxy groups having from 1 to 8 carbons (e.g. a methoxy group, an ethoxy group, an n-propoxy group, an iso-propoxy group, an n-butoxy group, a tert-butoxy group, a sec-butoxy group, an n-pentoxy group, an n-hexoxy group, a 1,2-dimethylbutoxy group, and the like), alkylalkoxy groups having from 2 to 8 carbons (e.g. a methylene methoxy group (—CH₃OCH₃), an ethylene methoxy group (—CH₂CH₂OCH₃), an n-propylene-iso-propoxy group (—CH₂CH₂CH₂OCH(CH₃)₂), a methylene-t-butoxy group (—CH₂—O—C(CH₃)₂, and the like), and the like.

Examples of the cations expressed by Formula (1) include imidazolium ions, pyridinium ions, pyrrolidinium ions, piperidinium ions, and the like.

Specific examples of preferred cations include the cations expressed by any one of Formulas (3) to (6) below.

Of these, the cations expressed by the following Formulas (3) and (5) are preferable because the photoelectric conversion efficiency of the photoelectric conversion element used in the electrolyte of the present invention (hereinafter also referred to as the “photoelectric conversion element of the present invention”) tends to be better.

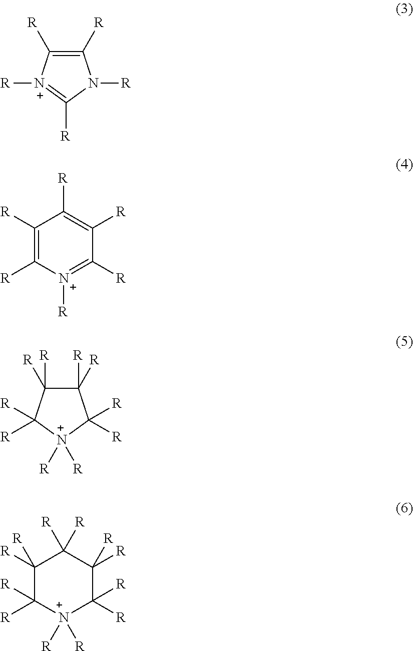

In Formulas (3) to (6), R are each independently a hydrogen atom or a hydrocarbon group having from 1 to 20 carbons that may include a hetero atom.

More specific examples include the following cations.

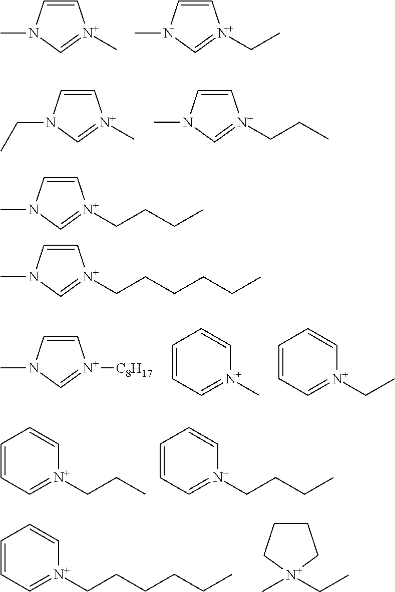

Examples of the cations of Formula (2) include organic cations such as ammonium ions, sulfonium ions, phosphonium ions, oxonium ions, and the like.

Specific examples of preferable cations are listed below.

Of these, aliphatic quarternary ammonium ions are preferable because the photoelectric conversion efficiency of the photoelectric conversion element of the present invention tends to be better.

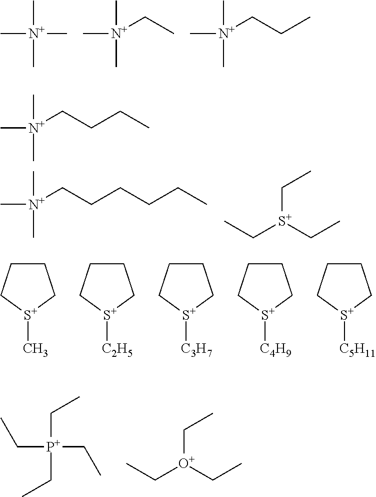

On the other hand, specific examples of preferably anions contained in the organic salt compound (A) include I⁻, Br⁻, AlCl₄⁻, Al₂Cl₇⁻, NO₃⁻, BF₄⁻, PF₆⁻, CH₃COO⁻, CF₃COO⁻, CF₃SO₃⁻, (CN)₄B⁻, SCN⁻, (CF₃SO₂)₂N⁻, (CN)₂N⁻, (CF₃SO₂)₃C⁻, (CN)₃C⁻, AsF₆⁻, SbF₆⁻, F(HF)ₙ⁻, CF₃CF₂CF₂CF₂SO₃⁻, (CF₃CF₂SO₂)₂N⁻, CF₃CF₂CF₂COO⁻, and the like. Moreover, phosphonate anions such as methylphosphonate or the like may be used.

Of these, the anions are preferably bromine ions (Br⁻) or iodine ions (I⁻) and more preferably iodine ions (I⁻) because the photoelectric conversion efficiency of the photoelectric conversion element of the present invention tends to be better.

Moreover, the thiocyanate anion (SCN⁻, here and below including the isothiocyanate anion, which is a linkage isomer) is preferably included from the standpoint of obtaining good heat resistance for the photoelectric conversion element of the present invention.

The organic salt compound (A) is exemplified by organic salt compounds such as those resulting from combinations of the aforementioned cited cations and anions.

Among such organic salt compounds, from the standpoint of further improvement of photoelectric conversion efficiency of the photoelectric conversion element of the present invention, the organic salt compound preferably has the imidazolium ion as the cation and has an iodine ion as the anion. From the standpoint of obtaining good heat resistance for the photoelectric conversion element of the present invention, an organic salt compound that has the thiocyanate anion is preferred, and an organic salt compound having the imidazolium ion and iodine ion and an organic salt compound having the thiocyanate anion are further preferably jointly used.

Additionally, a synthesis method of the organic salt compound (A) is not particularly limited, and various types of organic salt compounds obtained by combining the cations and the anions described above can be synthesized by a conventionally known method.

Synthesized products can be used as the organic salt compound (A) such as 1-methyl-3-methyl imidazolium iodide, 1-ethyl-3-methyl imidazolium iodide, 1-methyl-3-pentyl imidazolium iodide, 1-hexyl-3-methyl imidazolium iodide, 1-((2-methoxyethoxy)ethyl)-3-((2-methoxyethoxy)ethyl)imidazolium iodide, and the like; and also commercially available products can be used. Specific examples of commercially available products that can be used as the organic salt compound (A) include 1-methyl-3-propyl imidazolium iodide (manufactured by Tokyo Chemical Industry Co., Ltd.), 1-methyl-3-butyl imidazolium iodide (manufactured by Tokyo Chemical Industry Co., Ltd.), 1-methyl-1-methyl-pyrrolidinium iodide (manufactured by Sigma-Aldrich Co. LLC.), 1-ethyl-3-methyl imidazolium tetracyanoborate (manufactured by Merck), 1-ethyl-3-methyl imidazolium thiocyanate (manufactured by Merck), 1-ethyl-3-methyl imidazolium bis(trifluoromethylsulphonyl)imide (manufactured by Solvent Innovation), and the like.

The content of the aforementioned organic salt compound (A), relative to the total mass of the electrolyte of the present invention, is preferably from 50 to 95 mass %, and further preferably is from 65 to 95 mass %. If the content is within this range, the photoelectric conversion efficiency of the photoelectric conversion element of the present invention will be better.

### <Organically Modified Lamellar Double Hydroxide (B)>

The organically modified lamellar double hydroxide (B) used in the electrolyte of the present invention is obtained by organomodification of an untreated lamellar double hydroxide (referred to hereinafter simply as the “lamellar double hydroxide”) using an organic anion.

Due to the electrolyte of the present invention containing the aforementioned organically modified lamellar double hydroxide (B), the electrolyte becomes a gel-type electrolyte. Thus volatilization and leakage are suppressed for a long time interval after installation of the dye-sensitized solar cell using the electrolyte, and the dye-sensitized solar cell has excellent stability.

Firstly, the lamellar double hydroxide will be described below. Thereafter, the organomodification will be described.

### [Lamellar Double Hydroxide]

The lamellar double hydroxide generally has a layered structure formed by alternatingly stacking an oxide layer (formed from an oxide composed of a metal ion including a monovalent metal or divalent metal and a metal ion including a trivalent metal) and an inorganic anion intermediate layer. Water molecules are sandwiched between these layers (as interlayer water) of the layered structure. This lamellar double hydroxide normally has a crystalline structure.

The aforementioned monovalent metal is exemplified by Li. The aforementioned divalent metal is exemplified by Mg, Ca, Mn, Fe, Co, Ni, Cu, Zn, or the like. The aforementioned trivalent metal is exemplified by Al, Fe, Cr, Mn, Co, Ni, La, Ga, or the like.

The aforementioned oxide layer refers to a layer composed of a two dimensional row of oxygen octahedrons positioned centrally between the metal ions including a monovalent or divalent metal and the metal ions including a trivalent metal.

The expression “lamellar double hydroxide” in the present invention includes “hydrotalcite” and “hydrotalcite-like compounds”.

“Hydrotalcite” is the name given to the natural mineral Mg₆Al₂(OH)₁₆.OO₃.4 to 5H₂O.

The expression “hydrotalcite-like compound” is the name given to minerals that have a crystal structure that is identical or similar to that of “hydrotalcite,” as exemplified by (optionally synthetic) stichtite, pyroaurite, reevesite, takovite, honessite, iowaite, or the like. This type of “hydrotalcite-like compound” is indicated, for example, by the below listed Formula (7) or (8).

[M²⁺₁₋ₓM³⁺ₓ(OH)₂]^{x+}[Aⁿ⁻_{x/n}.mH₂O]^{x-} (7)

[Li⁺₁₋ₓM³⁺ₓ(OH)₂]^{(2x-1)+}[Aⁿ⁻₍₂ₓ₋₁₎/ₙ.mH₂O]^{(2x-1)-} (8)

In the aforementioned Formula (7), M²⁺ is at least one type of divalent metal ion selected from the group consisting of Mg, Ca, Mn, Fe, Co, Ni, Cu, and Zn. M³⁺ within the Formulae (7) and (8) is a metal ion of a trivalent metal of at least one type selected from the group consisting of Al, Fe, Cr, Mn, Co, Ni, La, and Ga. Aⁿ⁻ is at least one type of n-valent inorganic anion selected from the group consisting of OH⁻, ClO₃⁻, ClO₄⁻, F⁻, Cl⁻, Br⁻, I⁻, CO₃²⁻, NO₃⁻, and SO₄²⁻. Here, x is a positive number of 0<x<0.5, m is a positive number of 0<m, and n is the valence number of the aforementioned inorganic anion.

The divalent-trivalent system (i.e. combination of divalent ions and trivalent ions) indicated by the aforementioned Formula (7) is a non-stoichiometric compound (0<x<0.5), and non-stoichiometric compounds may be synthesized of composition ratios of various types of combinations.

The approximate crystal structure of this compound is described as follows. Firstly by partial replacement of the divalent metal ions (M²⁻) by the trivalent metal ions (M³⁺), a base layer ([M²⁺₁₋ₓM³⁺ₓ(OH)₂]^{x+}) is formed that resembles positively charged brucite (Mg(OH)₂). Then, in order to have electrical neutrality with this base layer, a negatively-charged inorganic anion intermediate layer ([Aⁿ⁻_{x/n}.mH₂O]^{x-}) is formed. Thus, a layered structure is formed from this base layer and the inorganic anion intermediate layer. Water molecules normally hydrogen bond with the hydroxyl groups of the base layer in this layered structure, and the aforementioned balance with the anion intermediate layer is maintained.

For the monovalent-trivalent system (i.e. combination of the monovalent ions and trivalent ions) indicated by the aforementioned Formula (8), a lamellar double hydroxide is reported to be obtainable that has a crystal structure resembling that described above. That is to say, the trivalent ion (e.g. Al) is arrayed in a Gibbsite structure, and the vacancies of the structures are occupied by monovalent metal ions (e.g. Li) to form a two-dimensional layer, and anions are incorporated in the layer in order to obtain the electrical charge of the layer.

The hydrotalcite and hydrotalcite-like compound have structural units composed of the positively charged base layer, the inorganic anion intermediate layer (which electrically neutralizes the positive charge), and water of crystallization. Although these structural units have differing structural breakdown temperatures, these structural elements also are known to display mostly similar properties, have solid basicity and anion exchangeability, and display specific reactions (i.e. intercalation-regeneration reactions).

The anion exchange capacity of the lamellar double hydroxide in the present invention is preferably from 150 to 500 milliequivalents per 100 g.

A suitable commercially marketed product may be used as this type of lamellar double hydroxide, as exemplified by Mg—Al-based carbonate type LDH (tradet name: DHT-6, manufactured by Kyowa Chemical Industry Co., Ltd.), Mg—Zn—Al-based carbonate type LDH (trade name: ALCAMIZER, manufactured by Kyowa Chemical Industry Co., Ltd.), Mg—Al-based carbonate type LDH (trade name: KYOWAAD 500, manufactured by Kyowa Chemical Industry Co., Ltd.), Mg—Al-based carbonate type LDH (trade name: KYOWAAD 1000, manufactured by Kyowa Chemical Industry Co., Ltd.), Mg—Al-based carbonate type LDH (trade name: STABIACE HT-1, manufactured by Sakai Chemical Co., Ltd.), Mg—Al-based carbonate type LDH (trade name: STABIACE HT-7, manufactured by Sakai Chemical Co., Ltd.), Mg—Al-based carbonate type LDH (trade name: STABIACE HT-P, manufactured by Sakai Chemical Co., Ltd.), or the like.

### [Organomodification]

In the organomodification, the exchangeable anion (inorganic anion) present between the layers of the lamellar double hydroxide is replaced by an organic anion.

### (Organic Anion)

No particular limitation is placed on the organic anion used in the aforementioned organomodification as long as the organic anion contains at least one carbon atom. However, for excellent moisture resistance of the photoelectric conversion element of the present invention by hydrophobizing, the organic anion preferably has three or more carbon atoms, further preferably is an organic anion having from 3 to 25 carbon atoms, and most preferably is an organic anion having from 5 to 20 carbon atoms.

In order to obtain good photoelectric conversion efficiency of the photoelectric conversion element of the present invention, the organic anion preferably has an onium base as a substituent. This type of organic anion will be described below in detail.

The organic anion used for the aforementioned organomodification is exemplified by organic anions derived from organic acids. Such organic acids are exemplified by carboxylic acids indicated by the below Formula (9), sulfonic acids indicated by the below Formula (10), organophosphorous compounds indicated by the below Formulae (11) to (14), or the like.

HOOC—R⁸ (9)

HO₃S—R⁸ (10)

(HO)₂P(═O)(OR⁸) (11)

(HO)P(═O)(OR⁸)₂ (12)

(HO)₂P(═O)R⁸ (13)

(HO)P(═O)R⁸₂ (14)

In the Formulae (9) to (14), R⁸ is an alkyl group having from 1 to 24 carbon atoms that may include a substituent or a hetero atom, an alkenyl group having from 2 to 24 carbon atoms that may include a substituent or a hetero atom, or an aryl group having from 6 to 24 carbon atoms that may include a substituent or a hetero atom.

In the aforementioned Formulae (12) and (14), multiple R⁸ groups may be the same or different.

The optionally substituted alkyl group indicated by R⁸ and having from 1 to 24 carbon atoms is exemplified by (either linear or branched) alkyl groups such as the methyl group, ethyl group, propyl group, butyl group, pentyl group, hexyl group, heptyl group, octyl group, nonyl group, decyl group, undecyl group, dodecyl group, tridecyl group, tetradecyl group, pentadecyl group, hexadecyl group, heptadecyl group, octadecyl group, nonadecyl group, icosyl group, henicosyl group, docosyl group, tricosyl group, tetracosyl group, or the like; such alkyl groups having a total carbon number of less than or equal to 24 and substituted by a fluorine atom, methyl group, ethyl group, hydroxy group, nitrile group, amino group, methoxy group, ethoxy group, isopropoxy group, phenyl group, naphthyl group, phenoxy group, naphthyloxy group, onium base, or the like; or the like.

The optionally substituted alkenyl group having from 2 to 24 carbon atoms and indicated by R⁸ is exemplified by (either linear or branched) alkenyl groups such as the vinyl group, propenyl group, isopropenyl group, butenyl group, pentenyl group, hexenyl group, heptenyl group, octenyl group, nonenyl group, decenyl group, undecenyl group, dodecenyl group, tridecenyl group, tetradecenyl group, pentadecenyl group, hexadecenyl group, heptadecenyl group, octadecenyl group, octadecadienyl group, nonadecenyl group, icocenyl group, henicocenyl group, docosenyl group, tricosenyl group, tetracosenyl group, or the like, where the position of the double bond is arbitrary; and alkenyl groups having a total of 24 or less carbon atoms and substituted thereby a fluorine atom, methyl group, ethyl group, hydroxy group, nitrile group, amino group, methoxy group, ethoxy group, isopropoxy group, phenyl group, naphthyl group, phenoxy group, naphthyloxy group, onium base, or the like; or the like.

The aryl group indicated by R⁸ and having from 6 to 20 carbon atoms that may include a substituent is exemplified by aryl groups such as the phenyl group, naphthyl group, or the like; and aryl groups having a total of 20 carbon atoms or less and substituted thereby the fluorine atom, methyl group, ethyl group, hydroxy group, nitrile group, amino group, methoxy group, ethoxy group, isopropoxy group, phenyl group, naphthyl group, phenoxy group, naphthyloxy group, onium base, or the like.

The carboxylic acid indicated by the aforementioned Formula (9) is exemplified by ethanoic acid (acetic acid), propanoic acid (propionic acid), butanoic acid (butyric acid), pentanoic acid, hexanoic acid, heptanoic acid, octanoic acid, nonanoic acid, decanoic acid, dodecanoic acid (lauric acid), tetradecanoic acid, hexadecanoic acid, heptadecanoic acid, octadecanoic acid (stearic acid), 9-hexadecenoic acid (palmitoleic acid), cis-9-octadecenoic acid (oleic acid), benzene carboxylic acid (benzoic acid), linoleic acid, linolenic acid, arachidonic acid, salicylic acid, phenylpropenoic acid, trihydroxy benzoic acid, carboxylic acids thereof having an onium base as a substituent, or the like. One of these may be used alone, or two or more may be used in combination.

From the standpoint of excellent moisture resistance of the photoelectric conversion element of the present invention, among such carboxylic acids, carboxylic acids are preferred that have three or more carbon atoms, and carboxylic acids are further preferred that have 5 to 20 carbon atoms. Preferred specific examples include pentanoic acid, hexanoic acid, heptanoic acid, octanoic acid, nonanoic acid, decanoic acid, dodecanoic acid (lauric acid), tetradecanoic acid, hexadecanoic acid, heptadecanoic acid, octadecanoic acid (stearic acid), oleic acid, linoleic acid, linolenic acid, arachidonic acid, salicylic acid, phenylpropenoic acid, and trihydroxy benzoic acid. Further preferred specific examples include pentanoic acid, hexanoic acid, heptanoic acid, octanoic acid, nonanoic acid, decanoic acid, dodecanoic acid (lauric acid), octadecanoic acid (stearic acid), oleic acid, linoleic acid, salicylic acid, phenylpropenoic acid, and trihydroxy benzoic acid.

The aforementioned sulfonic acid indicated by the Formula (10) is exemplified by methanesulfonic acid, 1-hexanesulfonic acid, 1-octanesulfonic acid, 1-decanesulfonic acid, 1-dodecanesulfonic acid, benzenesulfonic acid, 4-methylbenzenesulfonic acid, 2-dodecylbenzenesulfonic acid, camphor sulfonic acid, sulfonic acids thereof having an onium base as a substituent, or the like. One of these may be used alone, or two or more may be used in combination.

Among such sulfonic acids, from the standpoint of excellent moisture resistance of the photoelectric conversion element of the present invention, the sulfonic acid preferably has three or more carbon atoms, and the sulfonic acid further preferably has 5 to 20 carbon atoms. Specific examples include 1-hexanesulfonic acid, 1-octanesulfonic acid, 1-decanesulfonic acid, 1-dodecanesulfonic acid, benzenesulfonic acid, 4-methylbenzenesulfonic acid, 2-dodecylbenzenesulfonic acid, and camphor sulfonic acid. Further preferred examples of the sulfonic acid include 1-octanesulfonic acid, 1-decanesulfonic acid, 1-dodecanesulfonic acid, benzenesulfonic acid, 4-methylbenzenesulfonic acid, 2-dodecylbenzenesulfonic acid, and camphor sulfonic acid.

The aforementioned phosphoric acids indicated by the Formulae (11) to (14) are exemplified by methylphosphoric acids (mono-substituted, di-substituted, and mixtures thereof), ethylphosphoric acids (mono-substituted, di-substituted, and mixtures thereof), butylphosphoric acids (mono-substituted, di-substituted, and mixtures thereof), ethylhexylphosphoric acids (mono-substituted, di-substituted, and mixtures thereof), butoxyethylphosphoric acids (mono-substituted, di-substituted, and mixtures thereof), decylphosphoric acids (mono-substituted, di-substituted, and mixtures thereof), dodecylphosphoric acids (mono-substituted, di-substituted, and mixtures thereof), methoxypolyethyleneglycol phosphoric acids (mono-substituted, di-substituted, and mixtures thereof), polyethyleneglycol methacryloyloxy phosphoric acids (mono-substituted, di-substituted, and mixtures thereof), methylphosphonic acid, ethylphosphonic acid, vinylphosphonic acid, butylphosphonic acid, hexylphosphonic acid, octylphosphonic acid, decylphosphonic acid, dodecylphosphonic acid, methoxyphenylphosphonic acid, phosphoric acid derivatives thereof having an onium base as a substituent, or the like. One of these may be used alone, or two or more may be used in combination.

Among such phosphoric acid derivatives, from the standpoint of excellent moisture resistance of the photoelectric conversion element of the present invention, the phosphoric acid derivative preferably has three or more carbon atoms, and a phosphoric acid derivative having from 5 to 20 carbon atoms is further preferred. Further preferred phosphoric acid derivatives include ethylhexylphosphoric acid (mono-substituted, di-substituted, and mixtures thereof), butoxyethylphosphoric acid (mono-substituted, di-substituted, and mixtures thereof), decylphosphoric acid (mono-substituted, di-substituted, and mixtures thereof), dodecylphosphoric acid (mono-substituted, di-substituted, and mixtures thereof), methoxypolyethyleneglycol phosphoric acid (mono-substituted, di-substituted, and mixtures thereof), polyethyleneglycol methacryloyloxy phosphoric acid (mono-substituted, di-substituted, and mixtures thereof), hexylphosphonic acid, octylphosphonic acid, decylphosphonic acid, dodecylphosphonic acid, and methoxyphenylphosphonic acid.

The onium base (—Y⁺Z⁻) as a substituent will be described next.

The type of cation (Y⁻) occurring in the aforementioned onium base (—Y⁺Z⁻) is exemplified by the imidazolium ion, pyridinium ion, pyrrolidinium ion, piperidinium ion, ammonium ion, sulfonium ion, phosphonium ion, and oxonium ion cited as the cation of the organic salt compound (A). From the standpoint of good photoelectric conversion efficiency of the photoelectric conversion element of the present invention, the imidazolium ion, pyrrolidinium ion, piperidinium ion, ammonium ion, sulfonium ion, and phosphonium are further preferred.

On the other hand, the anion (Z⁻) of the aforementioned onium base (—Y⁺Z⁻) is exemplified by the anions cited as the anion of the organic salt compound (A). Further, due to the ability to readily exchange with the aforementioned anion of the organic salt compound (A), the anion (Z⁻), without particular limitation and from the standpoint of better photoelectric conversion efficiency of the photoelectric conversation element of the present invention, is preferably the bromide ion (Br⁻) or iodide ion (I⁻), and preferably is the iodide ion (I⁻).

In the organically modified lamellar double hydroxide that has been subjected to organomodification by the organic anion having the aforementioned onium base as a substituent, the aforementioned onium base (—Y⁺Z⁻) is arrayed along the entire oxide layer, and it is conjectured that photoelectric conversion efficiency of the photoelectric conversion element becomes good, for example, due to formation of an iodide ion (I⁻) path.

This type of organic anion preferably has the aforementioned onium base (—Y⁺Z⁻) and is exemplified by the organic anions indicated below by Formulae (15) to (18).

⁻OOC—(CH₂)ₙ—Y⁺Z⁻ (15)

⁻OO₂S—(CH₂)ₙ—Y⁺Z⁻ (16)

⁻OP(═O)(OH)—(CH₂)ₙ—Y⁺Z⁻ (17)

⁻C(CN)₂—CO—O—(CH₂)ₙ—Y⁺Z⁻ (18)

In the aforementioned Formulae (15) to (18), n indicates an integer ranging from 1 to 24, and preferably is an integer ranging from 1 to 20. Moreover, Y⁻ and Z⁻ are as described above.

Specific examples of the aforementioned organic anion indicated above by Formulae (15) to (18) in this manner include those described in the below described working examples.

### (Ion Exchange)

Ion exchange is performed by intercalation of the target anion (organic anion). This type of ion exchange is performed, for example, by direct exchange in aqueous solution, ion exchange by the regeneration method, or the like.

A lamellar double hydroxide that contains monovalent anions between layers is used as the lamellar double hydroxide for direct ion exchange in aqueous solution. Furthermore, nitrogen gas bubbling is preferably used in order to minimize intermixing of carbonate ions derived from the air. Since the carbonate ion has specific affinity for the lamellar double hydroxide, most anions exchange with the carbonate ion, and a carbonate ion type lamellar double hydroxide is formed. Thus, there are instances in which ion exchange is not possible with the target anion (organic anion).

Ion exchange by the regeneration method utilizes the property of regeneration of the lamellar double hydroxide to intercalate the target anion (organic anion) when the product of thermal decomposition of a lamellar double hydroxide is soaked in an aqueous solution.

That is to say, since an anion present in aqueous solution is incorporated in a product of thermal decomposition of a lamellar double hydroxide for regeneration when the product of thermal decomposition of the lamellar double hydroxide is soaked in the aqueous solution, by loading an aqueous solution beforehand with the desired anion (organic anion), it is possible to cause intercalation of the organic anion between layers during regeneration.

The temperature of heating in order to obtain the thermal decomposition product of the lamellar double hydroxide is preferably from 400 to 800° C. There is a tendency for regeneration of the lamellar double hydroxide to become difficult if the heating temperature is greater than or equal to the aforementioned upper limit. Moreover, if the heating temperature is not greater than or equal to the aforementioned lower limit, there is a tendency for carbonate ions to remain and for thermal decomposition to be insufficient.

The content of the aforementioned organically modified lamellar double hydroxide (B) obtained in this manner, is preferably from 1 to 250 parts by mass and further preferably is from 2 to 150 parts by mass (inorganic substance basis), per 100 parts by mass of the aforementioned organic salt compound (A).

Here, the expression “inorganic substance basis” means the weight-basis content in the aforementioned organically modified lamellar double hydroxide (B), excluding the interlayer anion, i.e. the aforementioned organic anion.

Moreover, although the aforementioned organically modified lamellar double hydroxide (B) is formed by the aforementioned ion exchange reaction, the interlayer of the lamellar double hydroxide is not necessarily completely intercalated by the organic anions.

### <Other Ingredients>

A redox couple can be added to the electrolyte of the present invention in order to enhance the photoelectric conversion efficiency of the photoelectric conversion element of the present invention.

Any conventional product commonly used for, or that can be used for, dye-sensitized solar cells may be used as the redox couple so long as the object of the present invention is not impaired.

For example, iodine/iodide ion pairs, bromine/bromide ion pairs, and the like can be used. Specific examples include iodine/iodide ion pairs such as metal iodides of iodine and LiI, NaI, KI, or the like, iodine salts of iodine and a quaternary imidazolium compound, iodine salts of iodine and a quaternary pyridinium compound, iodide salts of iodine and a tetraalkylammonium compound, and the like; bromine/bromide ion pairs such as metal bromide salts of bromine and LiBr, NaBr, KBr, or the like, bromide salts of bromine and a quaternary imidazolium compound, bromide salts of bromine and a quaternary pyridinium compound, bromide salts of bromine and a tetraalkylammonium compound, and the like; metal complexes such as ferrocyanide salt-ferricyanide salt, ferrocene-ferricynium salt, cobalt complexes, and the like; sulfer compounds of a di(poly)sulfide compound and a mercapto compound; hydroquinone-quinone; vilogen dyes; and the like. One of these may be used alone, or two or more may be used in combination.

Of these, iodine/iodide ion pairs and bromine/bromide ion pairs are preferable.

Additionally, an inorganic salt and/or an organic salt can be added to the electrolyte of the present invention in order to enhance short current of the photoelectric conversion element of the present invention.

Examples of the inorganic salt and/or organic salt include alkali metals, alkali earth metal salts, and the like, such as lithium iodide, sodium iodide, potassium iodide, magnesium iodide, calcium iodide, lithium trifluoroacetate, sodium trifluoroacetate, lithium thiocyanate, lithium tetrafluoroborate, lithium hexaphosphate, lithium perchlorate, lithium trifluoromethanesulfonate, lithium bis(trifluoromethanesulphonyl)imide, and the like. One of these may be used alone, or two or more may be used in combination.

An added amount of the inorganic salt and/or organic salt is not particularly limited and may be a conventional amount so long as the object of the present invention is not inhibited.

Additionally, a pyridine and/or a benzimidazole can be added to the electrolyte of the present invention in order to enhance the open voltage of the photoelectric conversion element of the present invention.

Specific examples include alkylpyridines such as methylpyridine, ethylpyridine, propylpyridine, butylpyridine, and the like; alkylimidazoles such as methylimidazole, ethylimidazole, propylimidazole, and the like; alkylbenzimidazoles such as methylbenzimidazole, ethylbenzimidazole, butylbenzimidazole, propylbenzimidazole, and the like; and the like. One of these may be used alone, or two or more may be used in combination.

An added amount of the pyridines and/or the benzimidazoles is not particularly limited and can be a conventional amount, so long as the object of the present invention is not inhibited.

### <Organic Solvent (C)>

The organic solvent (C) that is optionally contained in the electrolyte of the present invention is not particularly limited, provided that it is an organic solvent having a boiling point of 150° C. or more and a relative dielectric constant of 20 or more.

Here, “boiling point” refers to a boiling point at 1 atmosphere and “relative dielectric constant” refers to a value measured using a Liquid Dielectric Constant Meter (Liquid Dielectric Constant Meter Model M-870, manufactured by Nihon Rufuto, Co., Ltd.), having 25° C. and 10 kHz applied.

Specific examples of the organic solvent (C) include those mentioned in the specification of Japanese Patent Application No. 2010-243682.

When the aforementioned organic solvent (C) is contained, the content of the organic solvent (C) is preferably from 0.5 to 40 parts by mass, and further preferably is from 1 to 30 parts by mass per 100 parts by mass of the aforementioned organic salt compound (A). If the content is within this range, the photoelectric conversion efficiency of the photoelectric conversion element of the present invention will be better.

Moreover, when the aforementioned solvent (C) is contained, in order to maintain excellent moisture resistance for the photoelectric conversion element of the present invention, and in order to suppress elution of the photosensitizing dye (especially organic dye) in the dye-sensitized solar cell of the present invention, the ratio (C/A) of the aforementioned organic solvent (C) over the aforementioned organic salt compound (A) is preferably from 29/71 to 0.5/99.5, and further preferably is from 23/77 to 1/99.

### <Manufacturing Method>

No particular limitation is placed on the manufacturing method of the electrolyte of the present invention. For example, the electrolyte may be manufactured by blending the aforementioned organic salt compound (A), the aforementioned organically modified lamellar double hydroxide (B), and the like, by uniform dispersion (mixing-kneading) using a ball mill, sand mill, pigment disperser, grinder, ultrasonic disperser, homogenizer, planetary mixer, Hobart mixer, roll, kneader, or the like at room temperature or while heating (e.g. from 40 to 150° C.).

Here, as necessary, an organic solution (e.g. toluene or the like) can be mixed in with the mixture described above and, after the mixing, the organic solution may be removed using vacuum distillation.

### <Photoelectric Conversion Element, Dye-sensitized Solar Cell>

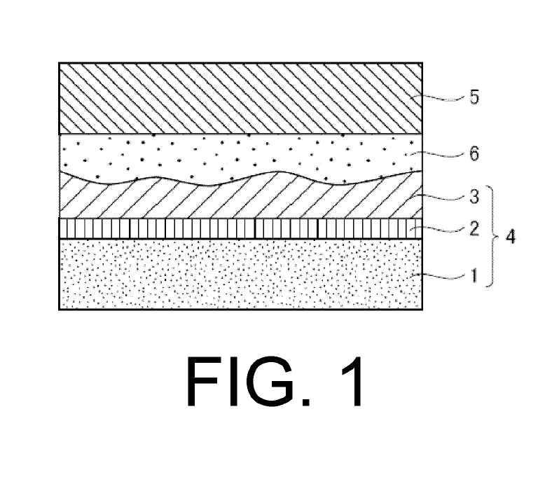

Next, the photoelectric conversion element and the dye-sensitized solar cell of the present invention will be described using FIG. 1. FIG. 1 is a schematic cross-sectional view illustrating an example of a basic configuration of a photoelectric conversion element of the present invention.

The photoelectric conversion element of the present invention includes a photoelectrode having a transparent conductive film and a metal oxide semiconductor porous film, a counterelectrode disposed so as to oppose the photoelectrode, and an electrolyte layer provided between the photoelectrode and the counterelectrode.

### <Photoelectrode>

As illustrated in FIG. 1, the photoelectrode is, for example, constituted by a transparent plate 1, a transparent conductive film 2, and an oxide semiconductor porous film 3.

Here, the transparent plate 1 preferably has excellent optical transparency, and specific examples include, in addition to glass plates, resin plates (films) such as polystyrene, polyethylene, polypropylene, polyethylene terephthalate, polyethylene naphthalate, polycarbonate, polyphenylene sulfide, cyclic olefin polymer, polyether sulfone, polysulfone, polyetherimide, polyarylate, triacetylcellulose, methyl polymethacrylate, and the like.

Additionally, specific examples of the transparent conductive film 2 include conductive metal oxides such as tin oxide doped with antimony or fluorine, zinc oxide doped with aluminum or gallium, indium oxide doped with tin, and the like.

Moreover, a thickness of the transparent conductive film 2 is preferably from about 0.01 to 1.0 μm.

Furthermore, the method for providing the transparent conductive film 2 is not particularly limited, and examples thereof include coating methods, sputtering methods, vacuum deposition methods, spray pyrolysis methods, chemical vapor deposition (CVD) methods, sol-gel methods, and the like.

Next, the oxide semiconductor porous film 3 is obtained by applying a dispersion of oxide semiconductor particles on the transparent conductive film 2.

Specific examples of the oxide semiconductor particles include titanium oxide, tin oxide, zinc oxide, tungstic oxide, zirconium oxide, hafnium oxide, strontium oxide, vanadium oxide, niobium oxide, and the like. One of these may be used alone, or two or more may be used in combination.

The dispersion is obtained by mixing the oxide semiconductor particles and a carrier medium using a disperser such as a sand mill, bead mill, ball mill, three-roll mill, colloid mill, ultrasonic homogenizer, Henschel mixer, jet mill, or the like.

Additionally, the dispersion, after being obtained by mixing using the disperser and immediately prior to use (application), is preferably subjected to ultrasonic treatment using an ultrasonic homogenizer or the like. By performing the ultrasonic treatment immediately prior to use, the photoelectric conversion efficiency of the photoelectric conversion element of the present invention will be better. Reasons for this are thought to be that the filling of the oxide semiconductor porous film, formed using the dispersion that had been subjected to ultrasonic treatment immediately prior to use, with the electrolyte of the present invention containing the organic salt compound (A) is facilitated and the adsorption capacity of the dye is increased.

Furthermore, acetyl acetone, hydrochloric acid, nitric acid, surfactants, chelating agents, and the like may be added to the dispersion in order to prevent the oxide semiconductor particles in the dispersion from re-aggregating; and a polymeric or cellulose-based thickening agent such as polyethylene oxide, polyvinylalcohol, and the like may be added to increase the viscosity of the dispersion.

Examples of commercially available products that can be used as the dispersion include titanium oxide pastes SP100 and SP200 (both manufactured by Showa Denko K.K.), titanium dioxide fine particle Ti-Nanoxide T (manufactured by Solaronix S.A.), Ti-Nanoxide D (manufactured by Solaronix S.A.), Ti-Nanoxide T/SP (manufactured by Solaronix S.A.), Ti-Nanoxide D/SP (manufactured by Solaronix S.A.), titania coating paste PECC01 (manufactured by Peccell Technologies), titania particle pastes PST-18NR and PST-400C (both manufactured by Nikki Chemical Co., Ltd.), and the like.

A conventional wet film forming method, for example, can be used as the method for applying the dispersion on the transparent conductive film.

Specific examples of the wet film forming method include screen printing methods, ink jet printing methods, roll coating methods, doctor blade methods, spincoating methods, spraying methods, and the like.

Additionally, after applying the dispersion on the transparent conductive film, a heat treatment, chemical treatment, plasma, or ozone treatment is preferably performed in order to enhance electronic contact between the particles, enhance adhesion with the transparent conductive film, and enhance film strength.

A temperature of the heat treatment is preferably from 40° C. to 700° C. and more preferably from 40° C. to 650° C. Additionally, a duration of the heat treatment is not particularly limited, but is normally from about 10 seconds to 24 hours.

Specific examples of the chemical treatment include chemical plating using a titanium tetrachloride aqueous solution, chemisorption using a carboxylic acid derivative, electrochemical plating using a titanium trichloride aqueous solution, and the like.

### <Counterelectrode>

As illustrated in FIG. 1, the counterelectrode is an electrode 5, disposed opposite a photoelectrode 4. For example, a metal plate, or a glass plate or a resin plate having a conductive film on a surface thereof, can be used.

Examples of metals that can be used as the metal plate include platinum, gold, silver, copper, aluminum, indium, titanium, and the like. Examples of resin plates that can be used include, in addition to the plate (film) exemplified by the transparent plate 1 that constitutes the photoelectrode 4, common resin plates that are non-transparent or have limited transparency.

Additionally, examples of the conductive film provided on the surface include conductive metal oxides and the like such as metals such as platinum, gold, silver, copper, aluminum, indium, titanium, and the like; carbon; tin oxide; tin oxides doped with antimony or fluorine; zinc oxide; zinc oxides doped with aluminum or gallium; indium oxides doped with tin; and the like. A thickness and a forming method of the conductive film are the same as for the transparent conductive film 2 that constitutes the photoelectrode 4.

In the present invention, an electrode having a conductive polymeric film formed on a plate or a conductive polymeric film electrode can be used as a counterelectrode 5.

Specific examples of the conductive polymer include polythiophene, polypyrrole, polyaniline, and the like.

Examples of a method for forming the conductive polymeric film on the plate include a method in which a conductive polymeric film from a polymeric dispersion is formed on a plate using a conventionally known wet film forming method such as a dipping method or a spin coating method.

Examples of products that can be used as the conductive polymeric dispersion include a polyaniline dispersion described in Japanese Unexamined Patent Application Publication No. 2006-169291, commercially available products such as a polythiophene derivative aqueous dispersion (Baytron P, manufactured by Bayer), Aquasave (manufactured by Mitsubishi Rayon, polyaniline derivative aqueous solution), and the like.

Additionally, when the plate is the conductive plate, in addition to the method described above, the conductive polymeric film can also be formed on the plate via an electrolysis polymerization method. The conductive polymeric film electrode can use a self-standing film wherein the conductive polymeric film formed on the electrode by the electrolysis polymerization method is peeled from the electrode, or a self-standing film formed using a casting method, a spin coating method, or the like that is conventionally known as a wet film forming method for forming a film from a conductive polymeric dispersion. Here, for convenience, a mixture of a state in which conductive polymeric particles are dispersed throughout the vehicle and a state in which conductive polymers are dissolved in the vehicle is referred to as the “conductive polymeric dispersion.”

### <Electrolyte Layer>

As illustrated in FIG. 1, the electrolyte layer is an electrolyte layer 6 that is provided between the photoelectrode 4 and the counterelectrode 5. The electrolyte of the present invention described above is used in the photoelectric conversion element of the present invention.

The photoelectric conversion element of the present invention can achieve superior moisture resistance because the electrolyte of the present invention described above is used.

The dye-sensitized solar cell of the present invention is a type of photoelectric conversion element wherein the photoelectrode constituting the photoelectric conversion element of the present invention described above carries a photosensitized dye.

Here, the photosensitized dye is not particularly limited so long as it is a dye having absorption in the visible light spectrum and/or infrared light spectrum, and a metal complex or an organic dye, or the like, can be used.

Specific examples of metal complexes that may be used include ruthenium complex dyes coordinated by a ligand structure such as that of bipyridine, terpyridine, or the like, and iron complex dyes, osmium complex dyes, platinum complex dyes, iridium complex dyes, or the like. Specific examples of organic dyes that may be used include porphyrin type dyes, phthalocyanine type dyes, cyanine type dyes, merocyanine type dyes, xanthene type dyes, coumarin type dyes, indole type dyes, fluorene type dyes, triphenylamine type dyes, or the like.

A method for applying the photosensitized dye is not particularly limited and can be applied by dissolving the dye described above in, for example, water, an alcohol-based solvent, or a nitrile-based solvent, and then immersing the oxide semiconductor porous film 3 in the dye solution or coating the dye solution on the oxide semiconductor porous film 3.

### EXAMPLES

The present invention is described below in detail using working examples. However, the present invention is in no way limited to these examples.

### Working Examples 1 to 135, Comparative Examples 1 to 14

### <Preparation of Organically Modified Lamellar Double Hydroxide>

The organically modified lamellar double hydroxide was prepared by the regeneration method using the regeneration property of the lamellar double hydroxide.

### (Organically Modified Lamellar Double Hydroxide 1)

A calcined lamellar double hydroxide was obtained by 12 h firing at 500° C. of a commercially marketed lamellar double hydroxide 1 (Mg—Al type lamellar double hydroxide, trade name: DHT-6, manufactured by Kyowa Chemical Industry Co., Ltd.). Thereafter, deionized water (dissolved carbon dioxide removed by bubbling of nitrogen gas) was used to prepare a 0.1M sodium stearate (manufactured by Kanto Chemical Co., Ltd.) aqueous solution. Then, 2 g of the obtained calcined lamellar double hydroxide was placed in 1 L of the aforementioned sodium stearate aqueous solution, and the mixture was stirred for 24 h. Thereafter, filtration and washing were repeated 3 times, followed by drying and grinding, to prepare the organically modified lamellar double hydroxide 1.

### (Organically Modified Lamellar Double Hydroxide 2 to 17)

Each of the organically modified lamellar double hydroxides 2 to 17 was prepared in the same manner as the organically modified lamellar double hydroxide 1 except for using the organic modifying agent indicated in the below Table 1.

TABLE 1

| Organically modified | | |
|---|---|---|
| lamellar double hydroxide | | Organic modifying agent |
| Organically modified | 1 | Sodium stearate (Kanto Kagaku) |
| lamellar double hydroxide | | |
| Organically modified | 2 | Sodium propionate (Kanto Kagaku) |
| lamellar double hydroxide | | |
| Organically modified | 3 | Sodium decanoate (Kanto Kagaku) |
| lamellar double hydroxide | | |
| Organically modified | 4 | Methoxypropylene glycol acetate |
| lamellar double hydroxide | | (Aldrich) |
| Organically modified | 5 | Sodium acetate (Kanto Kagaku) |
| lamellar double hydroxide | | |
| Organically modified | 6 | Sodium dodecylsulfonate (Kanto |
| lamellar double hydroxide | | Kagaku) |
| Organically modified | 7 | Sodium dodecylbenzenesulfonate |
| lamellar double hydroxide | | (Kanto Kagaku) |
| Organically modified | 8 | Sodium diethylhexyl sulfosuccinate |
| lamellar double hydroxide | | (Tokyo Chemical Industry Co., |
| | | Ltd.) |
| Organically modified | 9 | Sodium propanesulfonate (Tokyo |
| lamellar double hydroxide | | Chemical Industry Co., Ltd.) |
| Organically modified | 10 | Sodium polyoxyethylene lauryl |
| lamellar double hydroxide | | ether sulfate (Kao, EMAL 20C) |
| Organically modified | 11 | Sodium |
| lamellar double hydroxide | | methoxypolyethyleneglycolsulfonate |
| | | (for synthesis, refer to Working |
| | | Example 4 of Japanese Unexamined |
| | | Patent Application Publication No. |
| | | 2010-528172) |
| Organically modified | 12 | Methanesulfonic acid (Tokyo |
| lamellar double hydroxide | | Chemical Industry Co., Ltd.) |
| Organically modified | 13 | Ethyl phosphate (Johoku Chemical |
| lamellar double hydroxide | | Co., Ltd., JP502) |
| Organically modified | 14 | Sodium dodecyl phosphate (Tokyo |
| lamellar double hydroxide | | Chemical Industry Co., Ltd.) |
| Organically modified | 15 | Decylphosphonic acid (Tokyo |
| lamellar double hydroxide | | Chemical Industry Co., Ltd.) |
| Organically modified | 16 | Polyethyleneglycol methacryloyloxy |
| lamellar double hydroxide | | phosphate (Uni-Chemical K.K., |
| | | PHOSMER PP) |
| Organically modified | 17 | Methylcyclohexylamine phosphate |
| lamellar double hydroxide | | (Sigma-Aldrich Co. LLC.) |

### (Organically Modified Lamellar Double Hydroxide 18)

Firstly, an iodopropionic acid-derived lamellar double hydroxide precursor was obtained by intercalation by the organic anion indicated in the below Formula (19) and in the same manner as the organically modified lamellar double hydroxide 1 except for use of iodopropionic acid (manufactured by Sigma-Aldrich Co. LLC.).

Thereafter, a 0.1M aqueous solution of 1-methylimidazole (manufactured by Sigma-Aldrich Co. LLC.) was prepared. 2 g of the aforementioned precursor was loaded into 1 L of the aqueous solution, and the mixture was stirred for 24 h at room temperature. Thereafter, filtration and washing were repeated 3 times, followed by drying and grinding, to prepare the organically modified lamellar double hydroxide 18 intercalated by the organic anion indicated in the below Formula (20).

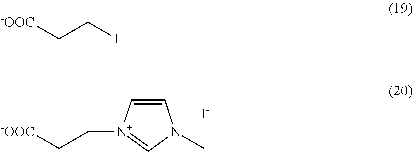

### (Organically Modified Lamellar Double Hydroxide 19 to 29)

The organically modified lamellar double hydroxides 19 to 29 intercalated using the organic anion (carboxylic acid derivative) indicated in the below Table 2 were prepared in the same manner as the organically modified lamellar double hydroxide 18.

### (Organically Modified Lamellar Double Hydroxide 30)

The compound of the below Formula (21) having a sulfonic acid and imidazolium salt was prepared by reaction of 1-methylimidazole (manufactured by Sigma-Aldrich Co. LLC.) and 1,3-propane sultone (manufactured by Sigma-Aldrich Co. LLC.) at 45° C. in acetone. The organically modified lamellar double hydroxide 30 intercalated using the compound indicated in the below Formula (22) was prepared in the same manner as organically modified lamellar double hydroxide 1 except for using the obtained organic anion and lithium iodide instead of sodium stearate.

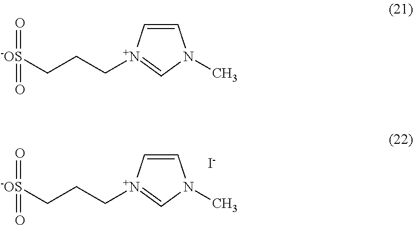

### (Organically Modified Lamellar Double Hydroxides 31 to 37)

The organically modified lamellar double hydroxides 31 to 37 intercalated using the organic anion (sulphonic acid derivative) indicated in the below Table 2 were prepared in the same manner as organically modified lamellar double hydroxide 30.

### (Organically Modified Lamellar Double Hydroxide 38)

Firstly, the bromopropyl phosphonic acid-derived lamellar double hydroxide precursor intercalated using the organic anion indicated in the below Formula (23) were obtained in the same manner as the organically modified lamellar double hydroxide 1 except for using bromopropyl phosphonic acid (manufactured by Tokyo Chemical Industry Co., Ltd.).

Thereafter, a 0.1M aqueous solution of 1-methylimidazole (manufactured by Sigma-Aldrich Co. LLC.) was prepared. 2 g of the aforementioned precursor was loaded into 1 L of this aqueous solution, and the mixture was stirred for 24 h at room temperature. Thereafter, filtration and washing were repeated 3 times, followed by drying and grinding, to prepare the organically modified lamellar double hydroxide 38 intercalated by the organic anion indicated in the below Formula (24).

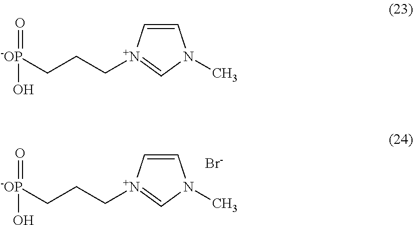

### (Organically Modified Lamellar Double Hydroxides 39 to 42)

The organically modified lamellar double hydroxides 39 to 42 intercalated using the organic anion (phosphoric acid derivative) indicated in the below Table 2 were prepared in the same manner as the organically modified lamellar double hydroxide 38.

### (Organically Modified Lamellar Double Hydroxide 43)

The compound of the below Formula (25) having an enolate anion and imidazolium salt was prepared by reaction of 1-methylimidazone (manufactured by Sigma-Aldrich Co. LLC.) and dicyanoketene ethylene acetal (manufactured by Sigma-Aldrich Co. LLC.) at 45° C. in acetone. The organically modified lamellar double hydroxide 43 intercalated using the compound indicated in the below Formula (26) was prepared in the same manner as the organically modified lamellar double hydroxide 1 except for using the obtained organic anion compound and lithium iodide instead of sodium stearate.

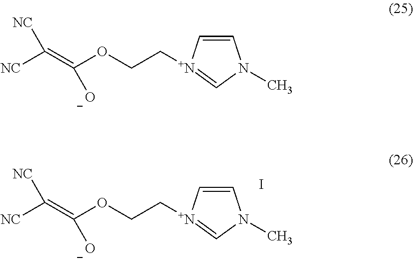

### (Organically Modified Lamellar Double Hydroxides 44 and 45)

The organically modified lamellar double hydroxides 44 and 45 intercalated by the organic anions indicated in the below Table 2 (organic anions having enolate anions) using a method similar to that used to prepare the organically modified lamellar double hydroxide 43.

TABLE 2

| Organically | | |
|---|---|---|
| modified lamellar | | |
| double hydroxide | | Organic anion |
| Organically modified lamellar double hydroxide | 18 | 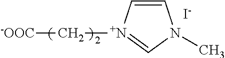 |
| Organically modified lamellar double hydroxide | 19 | 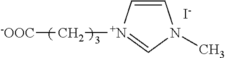 |
| Organically modified lamellar double hydroxide | 20 | 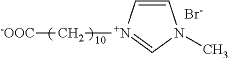 |
| Organically modified lamellar double hydroxide | 21 | 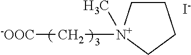 |
| Organically modified lamellar double hydroxide | 22 | 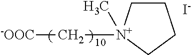 |
| Organically modified lamellar double hydroxide | 23 | 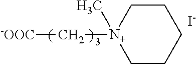 |
| Organically modified lamellar double hydroxide | 24 | 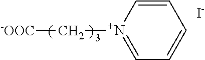 |
| Organically modified lamellar double hydroxide | 25 | 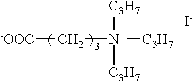 |
| Organically modified lamellar double hydroxide | 26 | 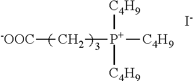 |
| Organically modified lamellar double hydroxide | 27 | 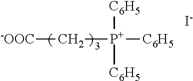 |
| Organically modified lamellar double hydroxide | 28 | 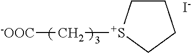 |
| Organically modified lamellar double hydroxide | 29 | 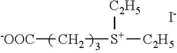 |
| Organically modified lamellar double hydroxide | 30 | 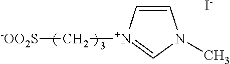 |
| Organically modified lamellar double hydroxide | 31 | 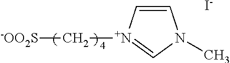 |
| Organically modified lamellar double hydroxide | 32 | 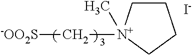 |
| Organically modified lamellar double hydroxide | 33 | 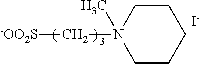 |
| Organically modified lamellar double hydroxide | 34 | 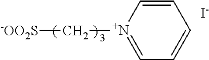 |
| Organically modified lamellar double hydroxide | 35 | 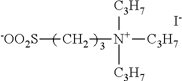 |
| Organically modified lamellar double hydroxide | 36 | 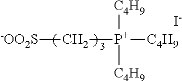 |
| Organically modified lamellar double hydroxide | 37 | 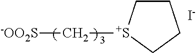 |
| Organically modified lamellar double hydroxide | 38 | 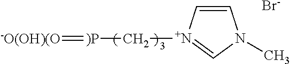 |
| Organically modified lamellar double hydroxide | 39 | 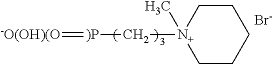 |
| Organically modified lamellar double hydroxide | 40 | 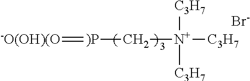 |
| Organically modified lamellar double hydroxide | 41 | 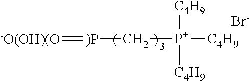 |
| Organically modified lamellar double hydroxide | 42 | 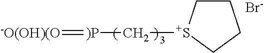 |
| Organically modified lamellar double hydroxide | 43 | 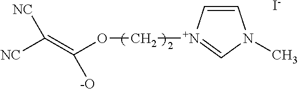 |
| Organically modified lamellar double hydroxide | 44 | 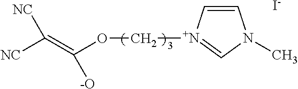 |
| Organically modified lamellar double hydroxide | 45 | 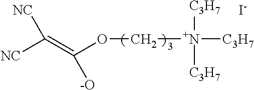 |

### <Preparation of Electrolyte>

In a mixing vessel, the respective ingredients indicated in the below Tables 3 to 12 were stirred and blended at the composition ratios (parts by mass) indicated in the below listed table to prepare the electrolyte.

Specifically, at the composition ratios indicated by the below respective table, to the organic salt compound 1 and/or 2 (i.e. ionic liquids indicated by the below respective table) a previously prepared dispersion obtained by dispersing and swelling the lamellar double hydroxide 1 and the organically modified lamellar double hydroxides 1 to 45 in solvent was added, and the mixture was stirred for 3 h at room temperature. Then, after the mixture was set aside, the solvent was removed to obtain a precipitate. Ethanol was used as the solvent for the organically modified lamellar double hydroxides 5, 12, and 17 and for the lamellar double hydroxide 1. Toluene was used as the solvent for the other organically modified lamellar double hydroxides. Thereafter, the obtained precipitate was washed using the utilized solvent, and then was dried to obtain a gel-like substance. Thereafter, iodine and N-methylbenzimidazole as shown in the below respective table were added to the obtained gel-like substance at the composition ratios indicated in the below respective table, and the mixture was blended.

In cases where the organically modified lamellar double hydroxide 1 to 45 or the lamellar double hydroxide 1 was not used, the organic salt compounds 1 and 2 were simply used as the electrolyte.

### <Fabrication of the Dye-Sensitized Solar Cell (Photosensitized Dye: Ruthenium Complex Dye)>

A titanium oxide paste (Ti-Nanoxide D, manufactured by Solaronix S.A.) was coated on transparent conductive glass (FTO glass, surface resistance: 15 Ω/square, manufactured by Nippon Sheet Glass Co., Ltd.) and dried at room temperature, and thereafter was sintered for 30 minutes at a temperature of 450° C. Thereby, a photoelectrode having a titanium oxide porous film formed on transparent conductive glass was fabricated.

The fabricated photoelectrode was then immersed for four hours in a ruthenium complex dye (cis-(diisothiocyanate)-N,N′-bis(2,2′-bipyridyl-4,4′-dicarboxylic acid)ruthenium(II)complex) (Ruthenium 535-bis TBA, manufactured by Solaronix S.A.) butyl alcohol/acetonitrile solution (Specific volume: 1/1; Concentration: 3×10⁴ mol/L).

Thereafter, the product was washed using acetonitrile and dried in a dark location under a stream of nitrogen. Thus, a photoelectrode carrying a photosensitized dye in a titanium oxide electrode of a photoelectrode was used as the photoelectrode.

The prepared electrolyte was applied on the photoelectrode carrying the photosensitized dye, and this and a platinum counterelectrode formed by forming a platinum film having a thickness of about 100 nm on a surface of a transparent conductive glass plate using a sputtering method (indium oxide doped with tin on a conductive face, sheet resistance: 8 Ω/square, manufactured by Nippon Sheet Glass Co., Ltd.) were bonded. When bonding, a thermal fusion bonding film was interposed between the photoelectrode and the platinum counterelectrode. Thermal fusion bonding was performed at 150° C. and a seal was formed between the electrodes. Thus, the dye-sensitized solar cell was obtained.

### <Fabrication of the Dye-Sensitized Solar Cell (Photosensitized Dye: Organic Dye)>

Other than using an indoline-based dye (D205, manufactured by Mitsubishi Paper Mills Limited) in place of the ruthenium complex dye, a dye-sensitized solar cell (photosensitized dye: organic dye) was fabricated according to the same method described above used in the fabrication of the dye-sensitized solar cell (photosensitized dye: ruthenium complex dye).

### <Evaluation>

The below listed evaluations were performed for the obtained two types of dye-sensitized solar cells. Results from the evaluations are shown in the below respective table.

### <Photoelectric Conversion Efficiency>

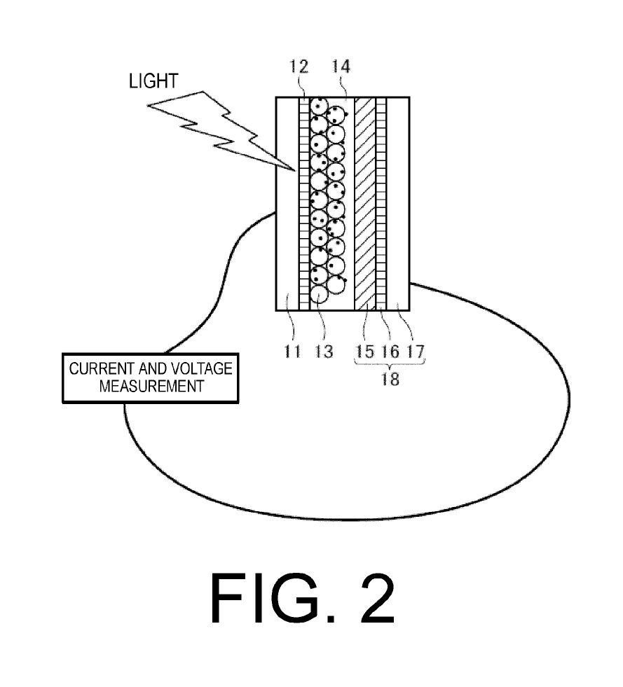

As illustrated in FIG. 2, a solar simulator is used as a light source, the photoelectrode side was irradiated with AM 1.5 artificial sunlight at a light intensity of 100 mW/cm², and the conversion efficiency (%) was calculated using a current-voltage measuring device (Digital Source Meter 2400, manufactured by Keithley Instruments Inc.).

### <Stability>

The presence or absence of volatilization and liquid leakage was checked for the dye-sensitized solar cell after production and vertical static placement for 1 week at 100° C. If either volatilization or liquid leakage was found, stability was evaluated as inferior (“x”). If neither volatilization nor liquid leakage was found, stability was evaluated as excellent (“o”).

### <Heat Resistance (Maintenance Factor)>

After measurement of photoelectric conversion efficiency, the dye-sensitized solar cell was left for 1,000 h at 85° C. temperature. Thereafter, photoelectric conversion efficiency was measured by the same method as described above, and the maintenance factor of photoelectric conversion efficiency was calculated (i.e. post-heating photoelectric conversion efficiency/pre-heating photoelectric conversion efficiency×100(%)).

Rate of change was evaluated as small and heat resistance was evaluated as excellent if the resultant maintenance factor of photoelectric conversion efficiency was 80% or more.

### <Moisture Resistance (Maintenance Factor)>

The dye-sensitized solar cell that was measured for photoelectric conversion efficiency was left for 1,000 hours at a temperature of 40° C. and an RH of 85% and, thereafter, was measured again for photoelectric conversion efficiency according to the same method described above. The maintenance factor (post-humidifying photoelectric conversion efficiency/pre-humidifying photoelectric conversion efficiency×100) (%) was calculated.

Rate of change was evaluated as small and moisture resistance was evaluated as excellent if the resultant maintenance factor of photoelectric conversion efficiency was 80% or more.

### <Moist Heat Resistance (Maintenance Factor)>

After measurement of photoelectric conversion efficiency, the dye-sensitized solar cell was left for 1,000 h at 85° C. temperature and 85% relative humidity conditions. Thereafter, photoelectric conversion efficiency was measured by the same method as described above, and the maintenance factor of photoelectric conversion efficiency was calculated (i.e. post-heating and post-humidification photoelectric conversion efficiency/pre-heating and pre-humidification photoelectric conversion efficiency×100(%)).

Rate of change was evaluated as small and moist heat resistance was evaluated as excellent if the resultant maintenance factor of photoelectric conversion efficiency was 80% or more.

TABLE 3

| | | Working Examples | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| A | Organic salt compound 1 (MPImI) | 100 | 100 | 100 | 100 | 100 | 100 | 100 | 100 | 100 | 100 | 100 | 100 |
| | Organic salt compound 2 (EMImSCN) | | | | | | | | | | | | |
| B | Organically modified lamellar | 5 | 10 | | | | | | | | | | |
| (indicated | double hydroxide 1 | | | | | | | | | | | | |
| as | Organically modified lamellar | | | 5 | 10 | | | | | | | | |
| inorganic | double hydroxide 2 | | | | | | | | | | | | |
| substance) | Organically modified lamellar | | | | | 10 | | | | | | | |
| | double hydroxide 3 | | | | | | | | | | | | |
| | Organically modified lamellar | | | | | | 10 | | | | | | |
| | double hydroxide 4 | | | | | | | | | | | | |
| | Organically modified lamellar | | | | | | | 10 | | | | | |
| | double hydroxide 5 | | | | | | | | | | | | |
| | Organically modified lamellar | | | | | | | | 5 | 10 | | | |
| | double hydroxide 6 | | | | | | | | | | | | |
| | Organically modified lamellar | | | | | | | | | | 5 | 10 | |
| | double hydroxide 7 | | | | | | | | | | | | |
| | Organically modified lamellar | | | | | | | | | | | | 10 |
| | double hydroxide 8 | | | | | | | | | | | | |

| | | | | | | | | | | | | |
|---|---|---|---|---|---|---|---|---|---|---|---|---|
| Iodine | 3.3 | 3.3 | 3.3 | 3.3 | 3.3 | 3.3 | 3.3 | 3.3 | 3.3 | 3.3 | 3.3 | 3.3 |
| N-methylbenzimidazole | 4.3 | 4.3 | 4.3 | 4.3 | 4.3 | 4.3 | 4.3 | 4.3 | 4.3 | 4.3 | 4.3 | 4.3 |
| Photoelectric conversion efficiency | 6.2 | 6.3 | 6.3 | 6.3 | 6.2 | 6.3 | 6.1 | 6.3 | 6.4 | 6.3 | 6.3 | 6.4 |
| Stability | ∘ | ∘ | ∘ | ∘ | ∘ | ∘ | ∘ | ∘ | ∘ | ∘ | ∘ | ∘ |
| Heat resistance (maintenance factor) [%] | 68 | 70 | 69 | 70 | 70 | 70 | 65 | 67 | 69 | 70 | 70 | 70 |
| Moisture resistance (maintenance factor) [%] | 82 | 84 | 81 | 82 | 83 | 83 | 72 | 81 | 85 | 81 | 82 | 83 |
| Moist heat resistance (maintenance factor) [%] | 65 | 67 | 65 | 65 | 65 | 65 | 56 | 64 | 65 | 65 | 65 | 64 |

| | | | | | | | | | | | Comparative | |
|---|---|---|---|---|---|---|---|---|---|---|---|---|
| | | Working Examples | | | | | | | | | Example | |
| | | 13 | 14 | 15 | 16 | 17 | 18 | 19 | 20 | 21 | 1 | 2 |
| A | Organic salt compound 1 (MPImI) | 100 | 100 | 100 | 100 | 100 | 100 | 100 | 100 | 100 | 100 | 100 |
| | Organic salt compound 2 | | | | | | | | | | | |
| | (EMImSCN) | | | | | | | | | | | |
| B (indicated as | Organically modified lamellar double | 10 | | | | | | | | | | |
| inorganic substance) | hydroxide 9 | | | | | | | | | | | |
| | Organically modified lamellar | | 10 | | | | | | | | | |
| | double hydroxide 10 | | | | | | | | | | | |
| | Organically modified lamellar | | | 10 | | | | | | | | |
| | double hydroxide 11 | | | | | | | | | | | |
| | Organically modified lamellar | | | | 10 | | | | | | | |
| | double hydroxide 12 | | | | | | | | | | | |
| | Organically modified lamellar | | | | | 10 | | | | | | |
| | double hydroxide 13 | | | | | | | | | | | |
| | Organically modified lamellar | | | | | | 10 | | | | | |
| | double hydroxide 14 | | | | | | | | | | | |
| | Organically modified lamellar | | | | | | | 10 | | | | |
| | double hydroxide 15 | | | | | | | | | | | |
| | Organically modified lamellar | | | | | | | | 10 | | | |
| | double hydroxide 16 | | | | | | | | | | | |
| | Organically modified lamellar | | | | | | | | | 10 | | |
| | double hydroxide 17 | | | | | | | | | | | |
| | Lamellar double hydroxide 1 | | | | | | | | | | 10 | |

| | | | | | | | | | | | |
|---|---|---|---|---|---|---|---|---|---|---|---|
| Iodine | 3.3 | 3.3 | 3.3 | 3.3 | 3.3 | 3.3 | 3.3 | 3.3 | 3.3 | 3.3 | 3.3 |
| N-methylbenzimidazole | 4.3 | 4.3 | 4.3 | 4.3 | 4.3 | 4.3 | 4.3 | 4.3 | 4.3 | 4.3 | 4.3 |
| Photoelectric conversion efficiency | 6.3 | 6.4 | 6.1 | 6.2 | 6.3 | 6.2 | 6.2 | 6.1 | 6.2 | 5.8 | 6.0 |
| Stability | ∘ | ∘ | ∘ | ∘ | ∘ | ∘ | ∘ | ∘ | ∘ | x | x |
| Heat resistance (maintenance factor) [%] | 69 | 71 | 70 | 64 | 70 | 69 | 67 | 70 | 64 | 58 | 55 |
| Moisture resistance (maintenance factor) [%] | 83 | 83 | 83 | 73 | 83 | 83 | 83 | 83 | 71 | 65 | 62 |
| Moist heat resistance (maintenance factor) [%] | 63 | 66 | 65 | 55 | 65 | 62 | 63 | 62 | 55 | 50 | 45 |

TABLE 4

| | | | | | | | | | | | | | Comparative | |
|---|---|---|---|---|---|---|---|---|---|---|---|---|---|---|
| | | Working Examples | | | | | | | | | | | Example | |
| | | 22 | 23 | 24 | 25 | 26 | 27 | 28 | 29 | 30 | 31 | 32 | 3 | 4 |
| A | Organic salt compound 1 | 75 | 75 | 75 | 75 | 75 | 75 | 75 | 75 | 75 | 75 | 75 | 75 | 75 |
| | (MPImI) | | | | | | | | | | | | | |
| | Organic salt compound 2 | 25 | 25 | 25 | 25 | 25 | 25 | 25 | 25 | 25 | 25 | 25 | 25 | 25 |
| | (EMImSCN) | | | | | | | | | | | | | |
| B | Organically modified lamellar | 10 | | | | | | | | | | | | |
| (indicated as | double hydroxide 1 | | | | | | | | | | | | | |
| inorganic | Organically modified lamellar | | 10 | | | | | | | | | | | |
| substance) | double hydroxide 2 | | | | | | | | | | | | | |
| | Organically modified lamellar | | | 10 | | | | | | | | | | |
| | double hydroxide 5 | | | | | | | | | | | | | |
| | Organically modified lamellar | | | | 10 | | | | | | | | | |
| | double hydroxide 6 | | | | | | | | | | | | | |
| | Organically modified lamellar | | | | | 10 | | | | | | | | |
| | double hydroxide 7 | | | | | | | | | | | | | |
| | Organically modified lamellar | | | | | | 10 | | | | | | | |
| | double hydroxide 9 | | | | | | | | | | | | | |
| | Organically modified lamellar | | | | | | | 10 | | | | | | |
| | double hydroxide 12 | | | | | | | | | | | | | |
| | Organically modified lamellar | | | | | | | | 10 | | | | | |
| | double hydroxide 13 | | | | | | | | | | | | | |
| | Organically modified lamellar | | | | | | | | | 10 | | | | |
| | double hydroxide 14 | | | | | | | | | | | | | |
| | Organically modified lamellar | | | | | | | | | | 10 | | | |
| | double hydroxide 15 | | | | | | | | | | | | | |
| | Organically modified lamellar | | | | | | | | | | | 10 | | |
| | double hydroxide 17 | | | | | | | | | | | | | |
| | Lamellar double hydroxide 1 | | | | | | | | | | | | 10 | |

| | | | | | | | | | | | | | |
|---|---|---|---|---|---|---|---|---|---|---|---|---|---|
| Iodine | 3.6 | 3.6 | 3.6 | 3.6 | 3.6 | 3.6 | 3.6 | 3.6 | 3.6 | 3.6 | 3.6 | 3.6 | 3.6 |
| N-methylbenzimidazole | 4.7 | 4.7 | 4.7 | 4.7 | 4.7 | 4.7 | 4.7 | 4.7 | 4.7 | 4.7 | 4.7 | 4.7 | 4.7 |
| Photoelectric conversion efficiency | 6.5 | 6.4 | 6.3 | 6.4 | 6.3 | 6.5 | 6.3 | 6.4 | 6.5 | 6.3 | 6.3 | 5.8 | 6.2 |
| Stability | ∘ | ∘ | ∘ | ∘ | ∘ | ∘ | ∘ | ∘ | ∘ | ∘ | ∘ | x | x |
| Heat resistance (maintenance factor) [%] | 83 | 82 | 81 | 82 | 83 | 81 | 81 | 82 | 82 | 81 | 80 | 74 | 71 |
| Moisture resistance (maintenance factor) [%] | 83 | 83 | 73 | 83 | 83 | 82 | 72 | 83 | 83 | 82 | 72 | 66 | 61 |
| Moist heat resistance (maintenance factor) | 82 | 83 | 64 | 83 | 82 | 82 | 63 | 83 | 82 | 83 | 63 | 50 | 46 |
| [%] | | | | | | | | | | | | | |

TABLE 5

| | | Working Examples | | | | | | | | | | | | |
|---|---|---|---|---|---|---|---|---|---|---|---|---|---|---|
| | | 33 | 34 | 35 | 36 | 37 | 38 | 39 | 40 | 41 | 42 | 43 | 44 | 45 |
| A | Organic salt compound 1 (MPImI) | 100 | 100 | 100 | 100 | 100 | 100 | 100 | 100 | 100 | 100 | 100 | 100 | 100 |
| | Organic salt compound 2 (EMImSCN) | | | | | | | | | | | | | |
| B (indicated as | Organically modified lamellar | 10 | 15 | | | | | | | | | | | |
| inorganic | double hydroxide 18 | | | | | | | | | | | | | |
| substance) | Organically modified lamellar | | | 10 | 15 | | | | | | | | | |
| | double hydroxide 19 | | | | | | | | | | | | | |
| | Organically modified lamellar | | | | | 10 | 15 | | | | | | | |
| | double hydroxide 20 | | | | | | | | | | | | | |
| | Organically modified lamellar | | | | | | | 15 | | | | | | |
| | double hydroxide 21 | | | | | | | | | | | | | |
| | Organically modified lamellar | | | | | | | | 15 | | | | | |
| | double hydroxide 22 | | | | | | | | | | | | | |
| | Organically modified lamellar | | | | | | | | | 15 | | | | |
| | double hydroxide 23 | | | | | | | | | | | | | |
| | Organically modified lamellar | | | | | | | | | | 15 | | | |
| | double hydroxide 24 | | | | | | | | | | | | | |
| | Organically modified lamellar | | | | | | | | | | | 15 | | |
| | double hydroxide 25 | | | | | | | | | | | | | |
| | Organically modified lamellar | | | | | | | | | | | | 15 | |
| | double hydroxide 26 | | | | | | | | | | | | | |
| | Organically modified lamellar | | | | | | | | | | | | | 15 |
| | double hydroxide 27 | | | | | | | | | | | | | |
| Iodine | | 3.3 | 3.3 | 3.3 | 3.3 | 3.3 | 3.3 | 3.3 | 3.3 | 3.3 | 3.3 | 3.3 | 3.3 | 3.3 |
| N-methylbenzimidazole | | 4.3 | 4.3 | 4.3 | 4.3 | 4.3 | 4.3 | 4.3 | 4.3 | 4.3 | 4.3 | 4.3 | 4.3 | 4.3 |
| Photoelectric conversion efficiency | | 6.8 | 7.2 | 6.9 | 7.3 | 6.7 | 7.0 | 7.2 | 7.1 | 7.0 | 7.1 | 7.1 | 7.0 | 7.2 |
| Stability | | ∘ | ∘ | ∘ | ∘ | ∘ | ∘ | ∘ | ∘ | ∘ | ∘ | ∘ | ∘ | ∘ |
| Heat resistance (maintenance factor) [%] | | 71 | 72 | 71 | 71 | 72 | 70 | 71 | 71 | 72 | 70 | 70 | 70 | 71 |
| Moisture resistance (maintenance factor) [%] | | 82 | 83 | 81 | 81 | 82 | 82 | 83 | 81 | 81 | 81 | 81 | 82 | 81 |
| Moist heat resistance (maintenance factor) [%] | | 68 | 67 | 67 | 66 | 65 | 67 | 67 | 68 | 67 | 66 | 65 | 67 | 64 |
| | | Working Examples | | | | | | | | | | | | |
| | | 46 | 47 | 48 | 49 | 50 | 51 | 52 | 53 | 54 | 55 | 56 | 57 | 58 |
| A | Organic salt compound 1 (MPImI) | 100 | 100 | 100 | 100 | 100 | 100 | 100 | 100 | 100 | 100 | 100 | 100 | 100 |
| | Organic salt compound 2 (EMImSCN) | | | | | | | | | | | | | |
| B (indicated as | Organically modified lamellar | 15 | | | | | | | | | | | | |
| inorganic | double hydroxide 28 | | | | | | | | | | | | | |
| substance) | Organically modified lamellar | | 15 | | | | | | | | | | | |
| | double hydroxide 29 | | | | | | | | | | | | | |
| | Organically modified lamellar | | | 10 | 15 | | | | | | | | | |
| | double hydroxide 30 | | | | | | | | | | | | | |
| | Organically modified lamellar | | | | | 10 | 15 | | | | | | | |
| | double hydroxide 31 | | | | | | | | | | | | | |
| | Organically modified lamellar | | | | | | | 15 | | | | | | |
| | double hydroxide 32 | | | | | | | | | | | | | |
| | Organically modified lamellar | | | | | | | | 15 | | | | | |
| | double hydroxide 33 | | | | | | | | | | | | | |
| | Organically modified lamellar | | | | | | | | | 15 | | | | |
| | double hydroxide 34 | | | | | | | | | | | | | |
| | Organically modified lamellar | | | | | | | | | | 15 | | | |
| | double hydroxide 35 | | | | | | | | | | | | | |
| | Organically modified lamellar | | | | | | | | | | | 15 | | |
| | double hydroxide 36 | | | | | | | | | | | | | |
| | Organically modified lamellar | | | | | | | | | | | | 15 | |
| | double hydroxide 37 | | | | | | | | | | | | | |
| | Organically modified lamellar | | | | | | | | | | | | | 15 |
| | double hydroxide 38 | | | | | | | | | | | | | |

| | | | | | | | | | | | | | |
|---|---|---|---|---|---|---|---|---|---|---|---|---|---|
| Iodine | 3.3 | 3.3 | 3.3 | 3.3 | 3.3 | 3.3 | 3.3 | 3.3 | 3.3 | 3.3 | 3.3 | 3.3 | 3.3 |
| N-methylbenzimidazole | 4.3 | 4.3 | 4.3 | 4.3 | 4.3 | 4.3 | 4.3 | 4.3 | 4.3 | 4.3 | 4.3 | 4.3 | 4.3 |
| Photoelectric conversion efficiency | 7.0 | 7.0 | 6.9 | 7.1 | 6.9 | 7.1 | 7.1 | 7.1 | 7.0 | 7.1 | 7.0 | 7.2 | 7.0 |
| Stability | ∘ | ∘ | ∘ | ∘ | ∘ | ∘ | ∘ | ∘ | ∘ | ∘ | ∘ | ∘ | ∘ |
| Heat resistance (maintenance factor) [%] | 71 | 72 | 72 | 72 | 73 | 71 | 71 | 71 | 72 | 73 | 71 | 72 | 73 |
| Moisture resistance (maintenance factor) [%] | 81 | 82 | 83 | 83 | 82 | 81 | 83 | 83 | 82 | 81 | 81 | 81 | 82 |
| Moist heat resistance (maintenance factor) [%] | 67 | 67 | 68 | 65 | 65 | 66 | 67 | 64 | 68 | 67 | 65 | 67 | 65 |

| | | Working Examples | | | | | | | Comparative Example | |
|---|---|---|---|---|---|---|---|---|---|---|
| | | 59 | 60 | 61 | 62 | 63 | 64 | 65 | 5 | 2 |
| A | Organic salt compound 1 (MPImI) | 100 | 100 | 100 | 100 | 100 | 100 | 100 | 100 | 100 |
| | Organic salt compound 2 (EMImSCN) | | | | | | | | | |
| B | Organically modified lamellar | 15 | | | | | | | | |
| (indicated as inorganic substance) | double hydroxide 39 | | | | | | | | | |
| | Organically modified lamellar | | 15 | | | | | | | |
| | double hydroxide 40 | | | | | | | | | |
| | Organically modified lamellar | | | 15 | | | | | | |
| | double hydroxide 41 | | | | | | | | | |
| | Organically modified lamellar | | | | 15 | | | | | |
| | double hydroxide 42 | | | | | | | | | |
| | Organically modified lamellar | | | | | 15 | | | | |
| | double hydroxide 43 | | | | | | | | | |
| | Organically modified lamellar | | | | | | 15 | | | |
| | double hydroxide 44 | | | | | | | | | |
| | Organically modified lamellar | | | | | | | 15 | | |
| | double hydroxide 45 | | | | | | | | | |
| | Lamellar double hydroxide 1 | | | | | | | | 15 | |

| | | | | | | | | | |
|---|---|---|---|---|---|---|---|---|---|
| Iodine | 3.3 | 3.3 | 3.3 | 3.3 | 3.3 | 3.3 | 3.3 | 3.3 | 3.3 |
| N-methylbenzimidazole | 4.3 | 4.3 | 4.3 | 4.3 | 4.3 | 4.3 | 4.3 | 4.3 | 4.3 |
| Photoelectric conversion efficiency | 7.0 | 7.1 | 7.0 | 7.0 | 7.1 | 7.1 | 7.0 | 5.8 | 6.0 |
| Stability | ∘ | ∘ | ∘ | ∘ | ∘ | ∘ | ∘ | x | x |
| Heat resistance (maintenance factor) [%] | 71 | 72 | 72 | 72 | 71 | 71 | 72 | 58 | 55 |
| Moisture resistance (maintenance factor) [%] | 82 | 82 | 81 | 81 | 82 | 82 | 81 | 65 | 62 |
| Moist heat resistance (maintenance factor) [%] | 68 | 67 | 65 | 66 | 66 | 64 | 68 | 50 | 45 |

TABLE 6
(1 of 2)

| | | Working Examples | | | | | | | | | | | | |
|---|---|---|---|---|---|---|---|---|---|---|---|---|---|---|
| | | 66 | 67 | 68 | 69 | 70 | 71 | 72 | 73 | 74 | 75 | 76 | 77 | 78 |
| A | Organic salt compound 1 (MPImI) | 75 | 75 | 75 | 75 | 75 | 75 | 75 | 75 | 75 | 75 | 75 | 75 | 75 |
| | Organic salt compound 2 (EMImSCN) | 25 | 25 | 25 | 25 | 25 | 25 | 25 | 25 | 25 | 25 | 25 | 25 | 25 |
| B | Organically modified lamellar | 15 | | | | | | | | | | | | |
| (indicated | double hydroxide 19 | | | | | | | | | | | | | |
| as inorganic | Organically modified lamellar | | 15 | | | | | | | | | | | |
| substance) | double hydroxide 20 | | | | | | | | | | | | | |
| | Organically modified lamellar | | | 15 | | | | | | | | | | |
| | double hydroxide 21 | | | | | | | | | | | | | |
| | Organically modified lamellar | | | | 15 | | | | | | | | | |
| | double hydroxide 23 | | | | | | | | | | | | | |
| | Organically modified lamellar | | | | | 15 | | | | | | | | |
| | double hydroxide 24 | | | | | | | | | | | | | |
| | Organically modified lamellar | | | | | | 15 | | | | | | | |
| | double hydroxide 25 | | | | | | | | | | | | | |
| | Organically modified lamellar | | | | | | | 15 | | | | | | |
| | double hydroxide 26 | | | | | | | | | | | | | |
| | Organically modified lamellar | | | | | | | | 15 | | | | | |
| | double hydroxide 27 | | | | | | | | | | | | | |
| | Organically modified lamellar | | | | | | | | | 15 | | | | |
| | double hydroxide 28 | | | | | | | | | | | | | |
| | Organically modified lamellar | | | | | | | | | | 15 | | | |
| | double hydroxide 29 | | | | | | | | | | | | | |
| | Organically modified lamellar | | | | | | | | | | | 15 | | |
| | double hydroxide 30 | | | | | | | | | | | | | |
| | Organically modified lamellar | | | | | | | | | | | | 15 | |
| | double hydroxide 32 | | | | | | | | | | | | | |
| | Organically modified lamellar | | | | | | | | | | | | | 15 |
| | double hydroxide 33 | | | | | | | | | | | | | |

| | | | | | | | | | | | | | |
|---|---|---|---|---|---|---|---|---|---|---|---|---|---|
| Iodine | 3.6 | 3.6 | 3.6 | 3.6 | 3.6 | 3.6 | 3.6 | 3.6 | 3.6 | 3.6 | 3.6 | 3.6 | 3.6 |
| N-methylbenzimidazole | 4.7 | 4.7 | 4.7 | 4.7 | 4.7 | 4.7 | 4.7 | 4.7 | 4.7 | 4.7 | 4.7 | 4.7 | 4.7 |
| Photoelectric conversion efficiency | 7.3 | 7.4 | 7.3 | 7.3 | 7.2 | 7.4 | 7.4 | 7.3 | 7.3 | 7.3 | 7.2 | 7.1 | 7.2 |
| Stability | ∘ | ∘ | ∘ | ∘ | ∘ | ∘ | ∘ | ∘ | ∘ | ∘ | ∘ | ∘ | ∘ |
| Heat resistance (maintenance factor) [%] | 87 | 87 | 87 | 88 | 87 | 87 | 87 | 87 | 85 | 87 | 87 | 87 | 87 |
| Moisture resistance (maintenance factor) [%] | 88 | 87 | 87 | 87 | 87 | 87 | 87 | 87 | 87 | 87 | 87 | 87 | 87 |
| Moist heat resistance (maintenance factor) [%] | 87 | 86 | 87 | 86 | 86 | 86 | 87 | 87 | 86 | 87 | 87 | 86 | 87 |

(2 of 2)

| | | | | | | | | | | | | | Comparative | |
|---|---|---|---|---|---|---|---|---|---|---|---|---|---|---|
| | | Working Examples | | | | | | | | | | | Example | |
| | | 79 | 80 | 81 | 82 | 83 | 84 | 85 | 86 | 87 | 88 | 89 | 5′ | 4 |
| A | Organic salt compound 1 (MPImI) | 75 | 75 | 75 | 75 | 75 | 75 | 75 | 75 | 75 | 75 | 75 | 75 | 75 |
| | Organic salt compound 2 (EMImSCN) | 25 | 25 | 25 | 25 | 25 | 25 | 25 | 25 | 25 | 25 | 25 | 25 | 25 |
| B | Organically modified lamellar | 15 | | | | | | | | | | | | |
| (indicated as | double hydroxide 34 | | | | | | | | | | | | | |
| inorganic | Organically modified lamellar | | 15 | | | | | | | | | | | |
| substance) | double hydroxide 35 | | | | | | | | | | | | | |
| | Organically modified lamellar | | | 15 | | | | | | | | | | |
| | double hydroxide 36 | | | | | | | | | | | | | |
| | Organically modified lamellar | | | | 15 | | | | | | | | | |
| | double hydroxide 37 | | | | | | | | | | | | | |
| | Organically modified lamellar | | | | | 15 | | | | | | | | |
| | double hydroxide 38 | | | | | | | | | | | | | |
| | Organically modified lamellar | | | | | | 15 | | | | | | | |
| | double hydroxide 39 | | | | | | | | | | | | | |
| | Organically modified lamellar | | | | | | | 15 | | | | | | |
| | double hydroxide 40 | | | | | | | | | | | | | |
| | Organically modified lamellar | | | | | | | | 15 | | | | | |
| | double hydroxide 41 | | | | | | | | | | | | | |
| | Organically modified lamellar | | | | | | | | | 15 | | | | |
| | double hydroxide 42 | | | | | | | | | | | | | |
| | Organically modified lamellar | | | | | | | | | | 15 | | | |
| | double hydroxide 43 | | | | | | | | | | | | | |
| | Organically modified lamellar | | | | | | | | | | | 15 | | |
| | double hydroxide 45 | | | | | | | | | | | | | |
| | Lamellar double hydroxide 1 | | | | | | | | | | | | 15 | |

| | | | | | | | | | | | | | |
|---|---|---|---|---|---|---|---|---|---|---|---|---|---|
| Iodine | 3.6 | 3.6 | 3.6 | 3.6 | 3.6 | 3.6 | 3.6 | 3.6 | 3.6 | 3.6 | 3.6 | 3.6 | 3.6 |
| N-methylbenzimidazole | 4.7 | 4.7 | 4.7 | 4.7 | 4.7 | 4.7 | 4.7 | 4.7 | 4.7 | 4.7 | 4.7 | 4.7 | 4.7 |
| Photoelectric conversion efficiency | 7.1 | 7.2 | 7.2 | 7.3 | 7.3 | 7.4 | 7.2 | 7.3 | 7.4 | 7.2 | 7.2 | 5.8 | 6.2 |
| Stability | ∘ | ∘ | ∘ | ∘ | ∘ | ∘ | ∘ | ∘ | ∘ | ∘ | ∘ | x | x |
| Heat resistance (maintenance factor) [%] | 87 | 87 | 85 | 87 | 87 | 86 | 87 | 87 | 87 | 86 | 87 | 74 | 71 |
| Moisture resistance (maintenance factor) [%] | 87 | 87 | 87 | 87 | 87 | 87 | 87 | 87 | 87 | 87 | 87 | 66 | 61 |
| Moist heat resistance (maintenance factor) [%] | 87 | 87 | 86 | 87 | 87 | 86 | 87 | 87 | 86 | 86 | 87 | 50 | 46 |

TABLE 7

| | | | | | | | | | | Comparative | |
|---|---|---|---|---|---|---|---|---|---|---|---|
| | | Working Examples | | | | | | | | Example | |
| | | 90 | 91 | 92 | 93 | 94 | 95 | 96 | 97 | 6 | 7 |
| A | Organic salt compound 1 (MPImI) | 71 | 67.5 | 60 | 60 | 60 | 60 | 60 | 60 | 60 | 60 |
| | Organic salt compound 2 (EMImSCN) | 24 | 22.5 | 20 | 20 | 20 | 20 | 20 | 20 | 20 | 20 |
| B | Organically modified lamellar | 10 | 10 | 10 | | | | | | | |
| (indicated as | double hydroxide 1 | | | | | | | | | | |
| inorganic | Organically modified lamellar | | | | 10 | | | | | | |
| substance) | double hydroxide 2 | | | | | | | | | | |
| | Organically modified lamellar | | | | | 10 | | | | | |
| | double hydroxide 6 | | | | | | | | | | |
| | Organically modified lamellar | | | | | | 10 | | | | |
| | double hydroxide 9 | | | | | | | | | | |
| | Organically modified lamellar | | | | | | | 10 | | | |
| | double hydroxide 13 | | | | | | | | | | |
| | Organically modified lamellar | | | | | | | | 10 | | |
| | double hydroxide 15 | | | | | | | | | | |
| | Lamellar double hydroxide 1 | | | | | | | | | 10 | |

| | | | | | | | | | | |
|---|---|---|---|---|---|---|---|---|---|---|
| Organic solvent (C) | 5 | 10 | 20 | 20 | 20 | 20 | 20 | 20 | 20 | 20 |
| Iodine | 3.3 | 3.3 | 3.3 | 3.3 | 3.3 | 3.6 | 3.6 | 3.6 | 3.3 | 3.3 |
| N-methylbenzimidazole | 4.3 | 4.3 | 4.3 | 4.3 | 4.3 | 4.7 | 4.7 | 4.7 | 4.3 | 4.3 |
| Photoelectric conversion efficiency | 6.6 | 6.8 | 6.9 | 7.1 | 7.0 | 7.1 | 7.1 | 7.0 | 6.7 | 7.0 |
| Stability | ∘ | ∘ | ∘ | ∘ | ∘ | ∘ | ∘ | ∘ | x | x |
| Heat resistance (maintenance factor) [%] | 83 | 84 | 82 | 82 | 83 | 82 | 83 | 83 | 72 | 68 |
| Moisture resistance (maintenance factor) [%] | 83 | 83 | 83 | 83 | 82 | 82 | 83 | 83 | 64 | 60 |
| Moist heat resistance (maintenance factor) [%] | 83 | 82 | 81 | 80 | 81 | 81 | 82 | 80 | 48 | 38 |

TABLE 8
(1 of 2)

| | | Working Examples | | | | | | | | | |
|---|---|---|---|---|---|---|---|---|---|---|---|
| | | 98 | 99 | 100 | 101 | 102 | 103 | 104 | 105 | 106 | 107 |
| A | Organic salt compound 1 (MPImI) | 71 | 67.5 | 60 | 60 | 60 | 60 | 60 | 60 | 60 | 60 |
| | Organic salt compound 2 (EMImSCN) | 24 | 22.5 | 20 | 20 | 20 | 20 | 20 | 20 | 20 | 20 |
| B | Organically modified lamellar | 15 | 15 | 15 | | | | | | | |
| (indicated as | double hydroxide 19 | | | | | | | | | | |
| inorganic | Organically modified lamellar | | | | 15 | | | | | | |
| substance) | double hydroxide 20 | | | | | | | | | | |
| | Organically modified lamellar | | | | | 15 | | | | | |
| | double hydroxide 21 | | | | | | | | | | |
| | Organically modified lamellar | | | | | | 15 | | | | |
| | double hydroxide 23 | | | | | | | | | | |
| | Organically modified lamellar | | | | | | | 15 | | | |
| | double hydroxide 25 | | | | | | | | | | |
| | Organically modified lamellar | | | | | | | | 15 | | |
| | double hydroxide 26 | | | | | | | | | | |
| | Organically modified lamellar | | | | | | | | | 15 | |
| | double hydroxide 28 | | | | | | | | | | |
| | Organically modified lamellar | | | | | | | | | | 15 |
| | double hydroxide 30 | | | | | | | | | | |

| | | | | | | | | | | |
|---|---|---|---|---|---|---|---|---|---|---|
| Organic solvent (C) | 5 | 10 | 20 | 20 | 20 | 20 | 20 | 20 | 20 | 20 |
| Iodine | 3.3 | 3.3 | 3.3 | 3.3 | 3.3 | 3.6 | 3.6 | 3.6 | 3.6 | 3.3 |
| N-methylbenzimidazole | 4.3 | 4.3 | 4.3 | 4.3 | 4.3 | 4.7 | 4.7 | 4.7 | 4.7 | 4.3 |
| Photoelectric conversion efficiency | 7.1 | 7.4 | 7.8 | 7.7 | 7.8 | 7.8 | 7.6 | 7.6 | 7.7 | 7.8 |
| Stability | ∘ | ∘ | ∘ | ∘ | ∘ | ∘ | ∘ | ∘ | ∘ | ∘ |
| Heat resistance (maintenance factor) [%] | 83 | 84 | 82 | 83 | 83 | 83 | 82 | 83 | 83 | 82 |
| Moisture resistance (maintenance factor) [%] | 84 | 83 | 83 | 83 | 84 | 83 | 83 | 83 | 83 | 83 |
| Moist heat resistance (maintenance factor) [%] | 83 | 82 | 82 | 83 | 82 | 82 | 81 | 82 | 82 | 83 |

(2 of 2)

| | | Working Examples | | | | | | | Comparative Example | |
|---|---|---|---|---|---|---|---|---|---|---|
| | | 108 | 109 | 110 | 111 | 112 | 113 | 114 | 8 | 7′ |
| A | Organic salt compound 1 (MPImI) | 60 | 60 | 60 | 60 | 60 | 60 | 60 | 60 | 60 |
| | Organic salt compound 2 (EMImSCN) | 20 | 20 | 20 | 20 | 20 | 20 | 20 | 20 | 20 |
| B | Organically modified lamellar | 15 | | | | | | | | |
| (indicated as | double hydroxide 33 | | | | | | | | | |
| inorganic | Organically modified lamellar | | 15 | | | | | | | |
| substance) | double hydroxide 35 | | | | | | | | | |
| | Organically modified lamellar | | | 15 | | | | | | |
| | double hydroxide 36 | | | | | | | | | |
| | Organically modified lamellar | | | | 15 | | | | | |
| | double hydroxide 37 | | | | | | | | | |
| | Organically modified lamellar | | | | | 15 | | | | |
| | double hydroxide 38 | | | | | | | | | |
| | Organically modified lamellar | | | | | | 15 | | | |
| | double hydroxide 39 | | | | | | | | | |
| | Organically modified lamellar | | | | | | | 15 | | |
| | double hydroxide 43 | | | | | | | | | |
| | Lamellar double hydroxide 1 | | | | | | | | 15 | |

| | | | | | | | | | |
|---|---|---|---|---|---|---|---|---|---|
| Organic solvent (C) | 20 | 20 | 20 | 20 | 20 | 20 | 20 | 20 | 20 |
| Iodine | 3.3 | 3.6 | 3.3 | 3.6 | 3.3 | 3.6 | 3.6 | 3.6 | 3.6 |
| N-methylbenzimidazole | 4.3 | 4.7 | 4.3 | 4.7 | 4.3 | 4.7 | 4.7 | 4.7 | 4.7 |
| Photoelectric conversion efficiency | 7.7 | 7.6 | 7.8 | 7.6 | 7.5 | 7.5 | 7.6 | 6.5 | 7.0 |
| Stability | ∘ | ∘ | ∘ | ∘ | ∘ | ∘ | ∘ | x | x |
| Heat resistance (maintenance factor) [%] | 83 | 83 | 83 | 83 | 82 | 82 | 83 | 73 | 68 |
| Moisture resistance (maintenance factor) [%] | 84 | 83 | 83 | 83 | 83 | 83 | 83 | 63 | 60 |
| Moist heat resistance (maintenance factor) [%] | 82 | 81 | 81 | 83 | 83 | 83 | 82 | 50 | 38 |

TABLE 9

| | | | | | | | | Comparative | |
|---|---|---|---|---|---|---|---|---|---|
| | | Working Examples | | | | | | Example | |
| | | 115 | 116 | 117 | 118 | 119 | 120 | 9 | 10 |
| A | Organic salt compound 1 (MPImI) | 100 | 100 | 100 | 100 | 100 | 100 | 100 | 100 |
| | Organic salt compound 2 (EMImSCN) | | | | | | | | |
| B | Organically modified lamellar | 10 | | | | | | | |
| (indicated as | double hydroxide 1 | | | | | | | | |
| inorganic | Organically modified lamellar | | 10 | | | | | | |
| substance) | double hydroxide 2 | | | | | | | | |
| | Organically modified lamellar | | | 10 | | | | | |
| | double hydroxide 6 | | | | | | | | |
| | Organically modified lamellar | | | | 10 | | | | |
| | double hydroxide 9 | | | | | | | | |
| | Organically modified lamellar | | | | | 10 | | | |
| | double hydroxide 13 | | | | | | | | |
| | Organically modified lamellar | | | | | | 10 | | |
| | double hydroxide 14 | | | | | | | | |
| | Lamellar double hydroxide 1 | | | | | | | 10 | |

| | | | | | | | | |
|---|---|---|---|---|---|---|---|---|
| Iodine | 3.3 | 3.3 | 3.3 | 3.3 | 3.3 | 3.3 | 3.3 | 3.3 |
| N-methylbenzimidazole | 4.3 | 4.3 | 4.3 | 4.3 | 4.3 | 4.3 | 4.3 | 4.3 |
| Photoelectric conversion efficiency | 5.8 | 5.7 | 5.8 | 5.8 | 5.7 | 5.7 | 5.5 | 5.8 |
| Stability | ∘ | ∘ | ∘ | ∘ | ∘ | ∘ | ∘ | x |
| Heat resistance (maintenance factor) [%] | 81 | 82 | 81 | 81 | 81 | 82 | 56 | 55 |
| Moisture resistance (maintenance factor) [%] | 85 | 86 | 84 | 85 | 86 | 86 | 67 | 65 |
| Moist heat resistance (maintenance factor) [%] | 81 | 81 | 81 | 81 | 81 | 82 | 35 | 38 |

TABLE 10

| | | | | | | | Comparative | |
|---|---|---|---|---|---|---|---|---|
| | | Working Examples | | | | | Example | |
| | | 121 | 122 | 123 | 124 | 125 | 11 | 10 |
| A | Organic salt compound 1 (MPImI) | 100 | 100 | 100 | 100 | 100 | 100 | 100 |
| | Organic salt compound 2 (EMImSCN) | | | | | | | |
| B | Organically modified lamellar | 15 | | | | | | |
| (indicated as | double hydroxide 18 | | | | | | | |
| inorganic | Organically modified lamellar | | 15 | | | | | |
| substance) | double hydroxide 20 | | | | | | | |
| | Organically modified lamellar | | | 15 | | | | |
| | double hydroxide 30 | | | | | | | |
| | Organically modified lamellar | | | | 15 | | | |
| | double hydroxide 38 | | | | | | | |
| | Organically modified lamellar | | | | | 15 | | |
| | double hydroxide 43 | | | | | | | |
| | Lamellar double hydroxide 1 | | | | | | 15 | |

| | | | | | | | |
|---|---|---|---|---|---|---|---|
| Iodine | 3.3 | 3.3 | 3.3 | 3.3 | 3.3 | 3.3 | 3.3 |
| N-methylbenzimidazole | 4.3 | 4.3 | 4.3 | 4.3 | 4.3 | 4.3 | 4.3 |
| Photoelectric conversion efficiency | 6.3 | 6.2 | 6.2 | 6.2 | 6.1 | 5.3 | 5.8 |
| Stability | ∘ | ∘ | ∘ | ∘ | ∘ | x | x |
| Heat resistance (maintenance factor) [%] | 81 | 82 | 82 | 82 | 81 | 56 | 55 |
| Moisture resistance (maintenance factor) [%] | 85 | 86 | 86 | 84 | 85 | 67 | 65 |
| Moist heat resistance (maintenance factor) [%] | 81 | 81 | 82 | 82 | 82 | 35 | 38 |

TABLE 11

| | | | | | | | Comparative | |
|---|---|---|---|---|---|---|---|---|
| | | Working Examples | | | | | Example | |
| | | 126 | 127 | 128 | 129 | 130 | 12 | 13 |
| A | Organic salt compound 1 (MPImI) | 60 | 60 | 60 | 60 | 60 | 60 | 60 |
| | Organic salt compound 2 (EMImSCN) | 20 | 20 | 20 | 20 | 20 | 20 | 20 |
| B | Organically modified lamellar | 10 | | | | | | |
| (indicated as | double hydroxide 1 | | | | | | | |
| inorganic | Organically modified lamellar | | 10 | | | | | |
| substance) | double hydroxide 2 | | | | | | | |
| | Organically modified lamellar | | | 10 | | | | |
| | double hydroxide 6 | | | | | | | |
| | Organically modified lamellar | | | | 10 | | | |
| | double hydroxide 9 | | | | | | | |
| | Organically modified lamellar | | | | | 10 | | |
| | double hydroxide 13 | | | | | | | |
| | Lamellar double hydroxide 1 | | | | | | 10 | |

| | | | | | | | |
|---|---|---|---|---|---|---|---|
| Organic solvent (C) | 20 | 20 | 20 | 20 | 20 | 20 | 20 |
| Iodine | 3.6 | 3.6 | 3.6 | 3.6 | 3.6 | 3.6 | 3.6 |
| N-methylbenzimidazole | 4.7 | 4.7 | 4.7 | 4.7 | 4.7 | 4.7 | 4.7 |
| Photoelectric conversion efficiency | 6.4 | 6.3 | 6.3 | 6.3 | 6.4 | 5.9 | 6.3 |
| Stability | ∘ | ∘ | ∘ | ∘ | ∘ | x | x |
| Heat resistance (maintenance factor) [%] | 82 | 82 | 82 | 81 | 81 | 62 | 62 |
| Moisture resistance (maintenance factor) [%] | 84 | 85 | 83 | 84 | 83 | 67 | 65 |
| Moist heat resistance (maintenance factor) [%] | 82 | 82 | 83 | 82 | 82 | 52 | 51 |

TABLE 12

| | | | | | | | Comparative | |
|---|---|---|---|---|---|---|---|---|
| | | Working Examples | | | | | Example | |
| | | 131 | 132 | 133 | 134 | 135 | 14 | 13 |
| | Organic salt compound 1 (MPImI) | 60 | 60 | 60 | 60 | 60 | 60 | 60 |
| | Organic salt compound 2 (EMImSCN) | 20 | 20 | 20 | 20 | 20 | 20 | 20 |
| B | Organically modified | 15 | | | | | | |
| (indicated as | lamellar double hydroxide 18 | | | | | | | |
| inorganic | Organically modified lamellar | | 15 | | | | | |
| substance) | double hydroxide 20 | | | | | | | |
| | Organically modified lamellar | | | 15 | | | | |
| | double hydroxide 30 | | | | | | | |
| | Organically modified lamellar | | | | 15 | | | |
| | double hydroxide 38 | | | | | | | |
| | Organically modified lamellar | | | | | 15 | | |
| | double hydroxide 43 | | | | | | | |
| | Lamellar double hydroxide 1 | | | | | | 15 | |

| | | | | | | | |
|---|---|---|---|---|---|---|---|
| Organic solvent (C) | 20 | 20 | 20 | 20 | 20 | 20 | 20 |
| Iodine | 3.6 | 3.6 | 3.6 | 3.6 | 3.6 | 3.6 | 3.6 |
| N-methylbenzimidazole | 4.7 | 4.7 | 4.7 | 4.7 | 4.7 | 4.7 | 4.7 |
| Photoelectric conversion efficiency | 6.8 | 6.9 | 6.9 | 6.8 | 6.8 | 5.7 | 6.3 |
| Stability | ∘ | ∘ | ∘ | ∘ | ∘ | x | x |
| Heat resistance (maintenance factor) [%] | 81 | 82 | 82 | 81 | 81 | 60 | 62 |
| Moisture resistance (maintenance factor) [%] | 84 | 85 | 83 | 84 | 83 | 67 | 65 |
| Moist heat resistance (maintenance factor) [%] | 81 | 82 | 83 | 82 | 82 | 52 | 51 |

The below listed ingredients were used as ingredients within the aforementioned tables.
Organic salt compound 1 (MPImI): 1-methyl-3-propylimidazolium iodide (manufactured by Tokyo Chemical Industry Co., Ltd.)
Organic salt compound 2 (EMImSCN): 1-ethyl-3-methylimidazolium thiocyanate (manufactured by Merck)
Organic solvent (C): methoxypropionitrile (boiling point: 166° C., relative dielectric constant: 25).

As made clear by the results indicated in each of the Working Examples 1 to 135 of the each aforementioned table, the rates of change of photoelectric conversion efficiency (heat resistance, moisture resistance, and moist heat resistance) were small, and even when the dye-sensitized solar cell was set aside for a long time interval, stability was found to be excellent in that liquid leakage or the like was prevented.

Moreover, heat resistance was found to be excellent for each of the Working Examples 22 to 32, 66 to 89, 90 to 114, and 126 to 135 utilizing the organic salt compound 2.

When Working Examples 1 to 6, 8 to 15, and 17 to 20 and Working Examples 7, 16, and 21 are compared, the Working Examples 1 to 6, 8 to 15, and 17 to 20 utilizing the organically modified lamellar double hydroxides 1 to 4, 6 to 11, and 13 to 16 were found to have excellent moisture resistance and moist heat resistance relative to the Working Examples 7, 16, and 21 utilizing the organically modified lamellar double hydroxides 5, 12, and 17. Similar results were found for Working Examples 22 to 32.

Also, the Working Examples 33 to 65 utilizing the organically modified lamellar double hydroxides 18 to 45 had excellent photoelectric conversion efficiency. For example, upon comparison between Working Examples 33, 35, 37, 48, and 50 with the Working Examples 2, 4 to 7, 9, and 11 to 21 utilizing the same amount of organically modified lamellar double hydroxide, photoelectric conversion efficiency was found to be higher for Working Examples 33, 35, 37, 48, and 50.

Moreover, upon comparison between the Working Example 33 and the Working Example 34, it was found that photoelectric conversion efficiency was excellent for Working Example 33, which had more of the organically modified lamellar double hydroxide 18. A similar trend was seen for Working Example 35 versus Working Example 36, Working Example 37 versus Working Example 38, Working Example 48 versus Working Example 49, and Working Example 50 versus Working Example 51.

This trend is similar to that of Working Examples 90 to 114, which jointly used organic salt compound and organic solvent.

Moreover, this trend is similar to that of Working Examples 115 to 135, which used organic dyes rather than ruthenium complex dye as the photosensitizing dye.

In contrast, Comparative Examples 1 to 14, which did not use the organically modified lamellar double hydroxides 1 to 45, were found to have large rates of change of the photoelectric conversion efficiency, liquid leakage or the like occurred when the dye-sensitized solar cell was left in place for a long time interval, and stability was found to be inferior.

### REFERENCE NUMERALS

1: Transparent plate
2: Transparent conductive film
3: Oxide semiconductor porous film
4: Photoelectrode
5: Counterelectrode
6: Electrolyte layer
11: Transparent plate
12: Transparent conductive film (ITO, FTO)
13: Metal oxide
14: Electrolyte
15: Platinum film
16: Transparent conductive film (ITO, FTO)
17: Plate
18: Counterelectrode

1. An electrolyte for a photoelectric conversion element comprising: an organic salt compound (A) having a tertiary or quaternary cation, and an organically modified lamellar double hydroxide (B).

2. The electrolyte for a photoelectric conversion element according to claim 1; wherein the organically modified lamellar double hydroxide (B) is a lamellar double hydroxide that has been subjected to organomodification using an organic anion having three or more carbons.

3. The electrolyte for a photoelectric conversion element according to claim 1; wherein the organically modified lamellar double hydroxide (B) is a lamellar double hydroxide that has been subjected to organomodification using an organic anion having an onium base.

4. The electrolyte for a photoelectric conversion element according to claim 3;
wherein the onium base is at least one type selected from the group consisting of an imidazolium base, a pyridinium base, a pyrrolidinium base, a piperidinium base, an ammonium base, a sulfonium base, a phosphonium base, or the like.

5. The electrolyte for a photoelectric conversion element according to claim 1; wherein
the organic salt compound (A) has a thiocyanate anion.

6. A photoelectric conversion element comprising: a photoelectrode including a transparent conductive film and a metal oxide semiconductor porous film;
a counterelectrode disposed opposite the photoelectrode; and
an electrolyte layer disposed between the photoelectrode and the counterelectrode, wherein
the electrolyte layer is the electrolyte for a photoelectric conversion element described in claim 1.

7. A dye-sensitized solar cell comprising the photoelectric conversion element described in claim 6; wherein
the photoelectrode of the photoelectric conversion element is carrying a photosensitizing dye.

8. The electrolyte for a photoelectric conversion element according to claim 2; wherein the organically modified lamellar double hydroxide (B) is a lamellar double hydroxide that has been subjected to organomodification using an organic anion having an onium base.

9. The electrolyte for a photoelectric conversion element according to claim 8;
wherein the onium base is at least one type selected from the group consisting of an imidazolium base, a pyridinium base, a pyrrolidinium base, a piperidinium base, an ammonium base, a sulfonium base, a phosphonium base, or the like.

10. The electrolyte for a photoelectric conversion element according to claim 2; wherein the organic salt compound (A) has a thiocyanate anion.

11. The electrolyte for a photoelectric conversion element according to claim 3; wherein the organic salt compound (A) has a thiocyanate anion.

12. The electrolyte for a photoelectric conversion element according to claim 4; wherein the organic salt compound (A) has a thiocyanate anion.

13. The electrolyte for a photoelectric conversion element according to claim 8; wherein the organic salt compound (A) has a thiocyanate anion.

14. The electrolyte for a photoelectric conversion element according to claim 9; wherein the organic salt compound (A) has a thiocyanate anion.
